(19) United States
(12) Patent Application Publication
(10) Pub. No.: US 2019/0001573 A1
(43) Pub. Date: Jan. 3, 2019

(54) TECHNOLOGIES OF PROGRAMMING MANUFACTURING MACHINES

(71) Applicants: Torbjørn Matre Gulbrandsen, Hønefoss (NO); Geir Brunes, Vikersund (NO); Krister Håkenrud, Hønefoss (NO); Brede Vigdal, Tyristrand (NO)

(72) Inventors: Torbjørn Matre Gulbrandsen, Hønefoss (NO); Geir Brunes, Vikersund (NO); Krister Håkenrud, Hønefoss (NO); Brede Vigdal, Tyristrand (NO)

(73) Assignee: NORSK TITANIUM AS, Hønefoss (NO)

(21) Appl. No.: 16/019,448

(22) Filed: Jun. 26, 2018

Related U.S. Application Data
(60) Provisional application No. 62/527,366, filed on Jun. 30, 2017.

(51) Int. Cl. B29C 64/393; B33Y 50/02; G06K 9/00; G06F 17/50

(52) U.S. Cl. CPC B29C 64/393; G06F 17/5086; G06K 9/00671; B33Y 50/02

(57) ABSTRACT

A system/method for converting a drawing into a model; slicing the model into a plurality of layers; creating a plurality of deposition schedules for the layers, wherein the deposition schedules correspond to the layers; generating a plurality of coordinate sets for the layers, wherein the coordinate sets correspond to the layers, wherein each of the coordinate sets includes a set of start coordinates and a set of end coordinates; selecting a plurality of features from a library for the layers; generating a program based on the features; outputting the program in a delimited format; running a simulation of a deposition based on the program in the delimited format; determining whether a result of the simulation is acceptable based on a parameter; and requesting an additive manufacturing machine to produce a workpiece responsive to the result being acceptable based on the parameter, wherein the workpiece is depicted in the drawing.

This application claims the priority benefit of U.S. Provisional Application No. 62/527,366 filed on Jun. 30, 2017, and which is hereby incorporated by reference in its entirety for all purposes as if fully set forth herein.

### BACKGROUND

### Technical Field

Generally, this disclosure relates to manufacturing systems. More particularly, this disclosure relates to process architectures for control of manufacturing systems.

### Discussion of Related Art

An additive manufacturing system, such as an additive metal deposition system or others, can rely on active feedback from a set of sensors in order to control, in real-time, a set of additive manufacturing parameters, such as a fed-stock rate, a stand-off distance, a plasma gas flow, a main current, a plasma transferred arc (PTA) current, a preheat current, or others. For example, an additive manufacturing system with an Interlayer Real-time Imaging and Sensing System (IRISS) technology includes a real-time adaptive control system that can sense and digitally self-adjust a metal deposition process with some degree of precision and repeatability. However, a technical problem exists when the active feedback from the set of sensors contains a large set of data. In particular, the large set of data is not only difficult to process in real-time, especially if data conflicts exist, but also can result in some uncontrolled variations in the set of additive manufacturing parameters during manufacturing, such as a traverse speed, a melt pool energy input, a thermal condition, or others. Such uncontrolled variations can result in some undesired workpiece characteristics, such as excessive material voids, low material strength, unwanted material properties, disproportionate material porosity, or others. Resultantly, the uncontrolled variations can have an adverse impact on an additive manufacturing workflow and on an ability to produce workpieces that have consistently repeatable material properties, which is especially important when seeking approval of safety regulators, such as in aerospace applications, automotive applications, medical applications, or others.

Furthermore, when the additive manufacturing system includes a metal deposition system, then the technical problem becomes more complex as most conventional metal deposition processes are not repeatable over time on a same machine basis and across multiple machines.

Additionally, before the additive manufacturing system begins to additively manufacture, a programmer needs to program the additive manufacturing system with a set of instructions. However, this type of programming is complex and requires excessive training to master. For example, in order to program the additive manufacturing system, the programmer needs to know multiple programming languages, such as G-code, CPL, or others, while having mastery of additive manufacturing process parameters, such as tolerances or others, and material properties, such as metal or others. Similarly, as workpiece design becomes more complicated, the set of instructions becomes more complex and difficult to manage. This is due to a large amount of programming details needed to be able to control material trajectory and process related parameters. For example, the programmer can write G-code structure with CPL functions in a text editor, such as Notepad, Notepad++, WordPad, or others. However, since the text editor is not adept in dealing with such programming syntax, the programmer becomes overly occupied with this time consuming and inflexible effort, which may include iterative code simulation and debugging. As such, there is a high risk of syntax errors during workpiece development, which can lead to a break-down of the additive manufacturing system. The breakdown interferes with an additive manufacturing workflow and is expensive to repair. Accordingly, there is a need to solve these and other technical problems.

### SUMMARY

Accordingly, provided are various technologies for additive manufacturing systems that effectively minimize or avoid reliance on the active feedback from the set of sensors in order to control, in real-time, the set of additive manufacturing parameters and thereby substantially obviate the technical problems due to limitations and disadvantages, as noted above. Also, provided are various technologies for programming additive manufacturing systems that simplify code creation and thereby substantially obviate the technical problem due to limitations and disadvantages, as noted above.

An advantage of various systems provided herein is to provide a manufacturing process, such as an additive manufacturing process or others, that involves a development of a set of executable-instructions for a workpiece to be manufactured. The set of executable-instructions is configuration-managed through a process control process, such as via following a standardized quality control process that regulates a development of the set of executable-instructions, a quality control of the set of executable-instructions, a release of the set of executable-instructions, an edit to the set of executable-instructions, or others. Once developed, the set of executable-instructions can be loaded into a machine interface of a manufacturing machine, such as a metal deposition machine or others, such that a plurality of workpieces can be manufactured with a set of consistent material properties. Additionally, as the manufacturing machine is calibrated to a common standard, the workpieces can be manufactured on other manufacturing machines.

Another advantage of various systems provided herein is to provide a simplified code creation technology that effectively reduces level of programming skill and manufacturing process mastery needed to program additive manufacturing systems.

Yet another advantage of various systems provided herein is to provide a user friendly interface for programming additive manufacturing systems, where such interface allows for simpler code management than a text editor, while allowing for a simplified debugging capability and effectively reducing syntax errors.

Additional features and advantages of the systems provided herein will be set forth in a detailed description which follows, and in part will be apparent from the detailed description, or can be learned by practice of this disclosure. Various objectives and other advantages of this disclosure will be realized and attained by a structure particularly pointed out in the detailed description and claims hereof as well as in a set of appended drawings.

To achieve these and other advantages and in accordance with a purpose of this disclosure, as embodied and broadly described, a system comprises: a human-machine interface (HMI) receiving a delimited file; a first programmable logic controller (PLC) in communication with the HMI such that the first PLC accesses the delimited file; and a second PLC in communication with the HMI and the first PLC, wherein the first PLC controls the second PLC based on the delimited file, wherein the second PLC controls a machine configured to additively manufacture a structure via melting a wire in a cloud of an inert gas using a set of instructions based on the delimited file.

In another embodiment, in accordance with a purpose of this disclosure, as embodied and broadly described, a method comprises converting, by a processor, a drawing into a model; slicing, by the processor, the model into a plurality of layers; creating, by the processor, a plurality of deposition schedules for the layers, wherein the deposition schedules one-to-one correspond to the layers; generating, by the processor, a plurality of coordinate sets for the layers, wherein the coordinate sets one-to-one correspond to the layers, wherein each of the coordinate sets includes a set of start coordinates and a set of end coordinates; selecting, by the processor, a plurality of features from a library for the layers; generating, by the processor, a program based on the features; outputting, by the processor, the program in a delimited format; running, by the processor, a simulation of a deposition based on the program in the delimited format; determining, by the processor, whether a result of the simulation is acceptable based on a parameter; and requesting, by the processor, an additive manufacturing machine to product a workpiece responsive to the result being acceptable based on the parameter, wherein the workpiece is depicted in the drawing.

In further embodiments, the method further comprises requesting, by the processor, a camera to capture an image of the workpiece; performing, by the processor, an object recognition process on the image; generating, by the processor, a first set of values based on the object recognition process; and comparing, by the processor, the first set of values against a second set of values such that a compliance of the workpiece to the second set of values is determined.

In further embodiments, the second set of values is based on a set of inputs from a user.

In further embodiments, the method further comprises outputting, by the processor, the program to a computing device.

In further embodiments, the program is in the delimited format when output to the computing device.

In further embodiments, the method further comprises forming, by the processor, an acoustic representation of the workpiece; performing, by the processor, an object recognition process on the acoustic representation; generating, by the processor, a first set of values based on the object recognition process; and comparing, by the processor, the first set of values against a second set of values such that a compliance of the workpiece to the second set of values is determined.

In further embodiments, the second set of values is based on a set of inputs from a user.

In further embodiments, the method further comprises outputting, by the processor, the program to a computing device.

In further embodiments, the program is in the delimited format when output to the computing device.

In further embodiments, the method further comprises forming, by the processor, a laser representation of the workpiece; performing, by the processor, an object recognition process on the laser representation; generating, by the processor, a first set of values based on the object recognition process; and comparing, by the processor, the first set of values against a second set of values such that a compliance of the workpiece to the second set of values is determined.

In further embodiments, the second set of values is based on a set of inputs from a user.

In further embodiments, the method further comprises outputting, by the processor, the program to a computing device.

In further embodiments, the program is in the delimited format when output to the computing device.

In further embodiments, the creating, the generating, and the selecting is consecutively and iteratively performed on a layer-by-layer basis.

In another embodiment, in accordance with a purpose of this disclosure, as embodied and broadly described, a system comprises a processor; and a memory storing a set of instructions that are executable by the processor, wherein the set of instructions instructs the processor to: convert a drawing into a model; slice the model into a plurality of layers; create a plurality of deposition schedules for the layers, wherein the deposition schedules one-to-one correspond to the layers; generate a plurality of coordinate sets for the layers, wherein the coordinate sets one-to-one correspond to the layers, wherein each of the coordinate sets includes a set of start coordinates and a set of end coordinates; select a plurality of features from a library for the layers; generate a program based on the features; output the program in a delimited format; run a simulation of a deposition based on the program in the delimited format; determine whether a result of the simulation is acceptable based on a parameter; and request an additive manufacturing machine to product a workpiece responsive to the result being acceptable based on the parameter, wherein the workpiece is depicted in the drawing.

In further embodiments, the set of instructions further instructs the processor to: request a camera to capture an image of the workpiece; perform an object recognition process on the image; generate a first set of values based on the object recognition process; and compare the first set of values against a second set of values such that a compliance of the workpiece to the second set of values is determined.

In further embodiments, the second set of values is based on a set of inputs from a user.

In further embodiments, the set of instructions instructs the processor to: output the program to a computing device.

In further embodiments, the program is in the delimited format when output to the computing device.

In further embodiments, the set of instructions instructs the processor to: form an acoustic representation of the workpiece; perform an object recognition process on the acoustic representation; generate a first set of values based on the object recognition process; and compare the first set of values against a second set of values such that a compliance of the workpiece to the second set of values is determined.

In further embodiments, the second set of values is based on a set of inputs from a user.

In further embodiments, the set of instructions instructs the processor to: output the program to a computing device.

In further embodiments, the program is in the delimited format when output to the computing device.

In further embodiments, the set of instructions instructs the processor to: form a laser representation of the workpiece; perform an object recognition process on the laser representation; generate a first set of values based on the object recognition process; and compare the first set of values against a second set of values such that a compliance of the workpiece to the second set of values is determined.

In further embodiments, the second set of values is based on a set of inputs from a user.

In further embodiments, the set of instructions instructs the processor to: output the program to a computing device.

In further embodiments, the program is in the delimited format when output to the computing device.

In further embodiments, the creating, the generating, and the selecting is consecutively and iteratively performed on a layer-by-layer basis.

In another embodiment, in accordance with a purpose of this disclosure, as embodied and broadly described, a method comprises generating, via a processor, a deposition template for an object based on a set of planar coordinates for the object stored in a spreadsheet and a set of features for the object stored in the spreadsheet, wherein the set of planar coordinates and the set of features are stored in the spreadsheet based on a first user input into an input device in communication with the processor; converting, via the processor, the deposition template from the spreadsheet into a delimited format; causing, via the processor, the deposition template in the delimited format to be input into a controller in communication with the processor, a human-machine interface (HMI), and an additive manufacturing system, wherein the processor is distinct from the HMI, wherein the controller is communicably interposed between the processor and the HMI unit, wherein the controller is communicably interposed between the HMI unit and the additive manufacturing system; causing, via the processor, a logic to be started on the controller based on a second user input into the HMI as the controller stores the deposition template in the delimited format; causing, via the processor, the logic to read the deposition template in the delimited format stored on the controller such that the logic generates a set of syntax commands on the controller; causing, via the processor, the set of syntax commands to be sent from the logic on the controller to the additive manufacturing system; and causing, via the processor, the object to be additively manufactured via the additive manufacturing system based on the set of syntax commands.

In further embodiments, the delimited format includes a comma-separated value (CSV) format exported via the spreadsheet.

In further embodiments, the deposition template is editable via a customized ribbon in the spreadsheet, wherein the customized ribbon contains an icon related to at least one of the set of planar coordinates or the set of features.

In further embodiments, the set of planar coordinates is based on a drawing.

In further embodiments, the set of planar coordinates is generated based on a data structure describing the object.

In further embodiments, the set of planar coordinates is input before the set of features.

In further embodiments, the deposition template is converted into the delimited format based on no errors being detected in the deposition template as the deposition template is error checked via the spreadsheet.

In further embodiments, the template is a visual basic for applications (VBA) for a spreadsheet worksheet.

The present disclosure discloses various technical solutions to various technical problems identified above. These technical solutions solve these technical problems in various unconventional ways. For example, in some embodiments, generating a program in a delimited format based on a feature selected from a library of layers formed from a model reduces reliance on active sensor feedback during manufacturing due to the delimited format. Similarly, in some embodiments, the delimited format simplifies code creation and reduces syntax errors due to its structure. Likewise, the delimited format enables reduction of data conflicts and uncontrolled workpiece variations due its delimited structure. Similarly, the delimited format enables increasing workpiece consistency and machine repeatability due to its format.

It is to be understood that both the foregoing general description and the following detailed description are exemplary and explanatory and are intended to provide further explanation of claims, as further recited below.

### BRIEF DESCRIPTION OF DRAWINGS

The set of appended drawings, which are included to provide a further understanding of this disclosure and are incorporated in and constitute a part of this specification, illustrate embodiments of this disclosure and together with the detailed description serve to explain various principles of this disclosure.

In the set of appended drawings:

FIG. 1 is a block diagram of an embodiment of a control hierarchy and distribution schema of a manufacturing system according to this disclosure.

FIG. 2 is a block diagram of an embodiment of a logic architecture according to this disclosure.

FIG. 3 is a flowchart of an embodiment of a process for executing a logic for additive manufacturing according to this disclosure.

FIG. 4 is a flowchart of an embodiment of a define jig function process according to this disclosure.

FIG. 5 is a flowchart of an embodiment of a define deposition tool function process according to this disclosure.

FIG. 6 is a flowchart of an embodiment of a data check function process according to this disclosure.

FIG. 7 is a flowchart of an embodiment of a read data function process according to this disclosure.

FIG. 8 is a flowchart of an embodiment of a run string function process according to this disclosure.

FIG. 9 is a flowchart of an embodiment of a dry run function process according to this disclosure.

FIG. 10 is a flowchart of an embodiment of a temperature process according to this disclosure.

FIG. 11 is a flowchart of an embodiment of a temperature process according to this disclosure.

FIG. 12 shows a diagram of an embodiment of a topology according to this disclosure.

FIG. 13 shows a flowchart of an embodiment of a process for generating a delimited file according to this disclosure.

FIG. 14 shows a diagram of an embodiment of an additive manufacturing process according to this disclosure.

FIG. 15 shows a screenshot of an embodiment of a menu according to this disclosure.

FIG. 16 shows a diagram of an embodiment of a process of using a PLC with a delimited file according to this disclosure.

### DETAILED DESCRIPTION OF ILLUSTRATED EMBODIMENTS

This disclosure is now described more fully with reference to the set of accompanying drawings, in which some embodiments of this disclosure are shown. This disclosure can, however, be embodied in many different forms and should not be construed as necessarily being limited to the embodiments disclosed herein. Rather, these embodiments are provided so that this disclosure is thorough and complete, and fully conveys various concepts of this disclosure to skilled artisans. Reference will now be made in detail to an embodiment of this disclosure, an example of which is illustrated in the set of appended drawings.

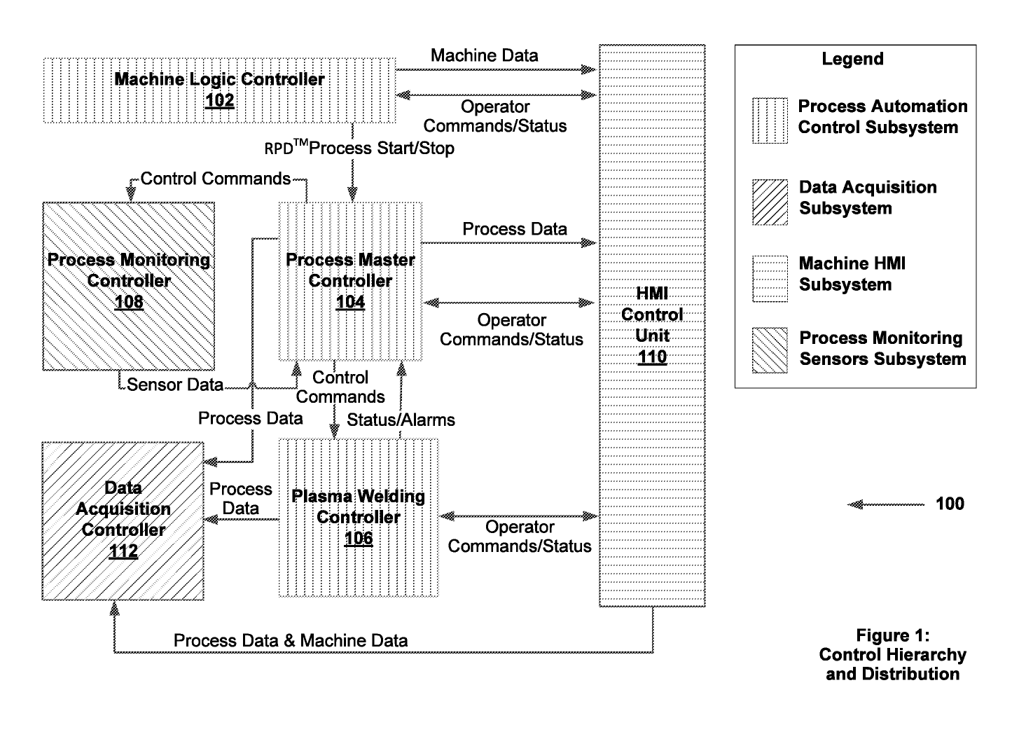

FIG. 1 is a block diagram of an embodiment of a control hierarchy and distribution schema of a manufacturing system according to this disclosure. In particular, a control hierarchy and distribution schema 100 of an additive manufacturing system is disclosed. For example, the additive manufacturing system can include a metal deposition system, a 3-D printing system, or others. For example, the metal deposition system can be configured to deposit a metal, an alloy, or others, including combinations thereof. For example, the metal can include titanium or others, or the metal alloy can include steel, brass, bronze, or others. For example, the metal deposition system can include a rapid plasma deposition system, such as where a metal in a wire form, such as a wire including titanium or others, is melted in a cloud of an inert gas, such as argon or others, and precisely and rapidly built up in layers via a robotic layer-building process to a near-net-shape, such as up to 80% complete or even more, that requires minimum finish machining. For example, the metal deposition system may be a system such as disclosed in U.S. patent application Ser. No. 15/206,163 and U.S. Pat. Nos. 7,301,120; 7,326,377; 9,346,116; and 9,481,931, all of which are hereby fully incorporated by reference herein for all purposes. For example, the metal deposition system can be configured for at least one of a solid free form deposition, an additive deposition, a 3D deposition, or others. For example, the metal deposition system can include a Merke IV machine from Norsk Titanium, which is able to receive a file of a workpiece design, such as a computer-aided design (CAD) file or others, and a spool of a wire, such as a wire including titanium or others, and produce a workpiece, which can be aerospace-grade or others, based on a specific workpiece geometry, as extracted from the file of the workpiece design. For example, the metal deposition system can be encased in or include a chamber filled with an inert gas, such as argon, helium, xenon, krypton, or combinations thereof. For example, the 3-D printing system can be configured to additively deposit a plastic or others. Note though that non-additive manufacturing system can be used as well, such as a subtractive manufacturing system or others.

The control hierarchy and distribution schema 100 includes a plurality of subsystem blocks, including a process automation control subsystem block, a data acquisition subsystem block, a machine HMI subsystem block, and a process monitoring sensors subsystem block. Note that other subsystems blocks are possible, such as a data security subsystem block or others. The process automation control subsystem block includes a machine logic controller 102, a process master controller 104, and a plasma welding controller 106. The data acquisition subsystem block includes a data acquisition controller 112. The machine HMI subsystem block includes an HMI control unit 110. The process monitoring sensors subsystem block includes a process monitoring controller 108.

The machine logic controller 102 can be embodied as hardware, such as a set of circuitry in any form, such as a PLC, or software, such as a set of executable instructions in any form, such as an executable code. The machine logic controller 102 communicably interfaces with the HMI control unit 110 and the process master controller 104. The machine logic controller 102 acts as a machine control master handling a set of machine states, maintaining an inert atmosphere required for a material deposition process, and handling a set of safety parameters. The machine logic controller 102 employs the process master controller 104 for activities related to the material deposition process. Apart from these, most or all mechanical drives and axis coordinates are controlled by the process master controller due to various input/output (TO) constraints and performance requirements. In such cases, the machine logic controller 102 calls a set of corresponding functions as and when required, whether the set of corresponding functions is stored local to or remote from the machine logic controller 102.

The process master controller 104 can be embodied as hardware, such as a set of circuitry in any form, such as a PLC, or software, such as a set of executable instructions in any form, such as an executable code. The process master controller 104 communicably interfaces with the HMI control unit 110, the plasma welding controller 106, the data acquisition controller 112, the process monitoring controller 108, and the machine logic controller 102. The process master controller 104 handles some, most, or all material deposition process related activities, such as parsing a material deposition set of executable instructions, controlling a set of positioning equipment, controlling a wire feed, controlling a process thermal input, monitoring a process parameter, controlling a process parameter, accessing a feature library in a data store, accessing a weld recipe in a data store, and handles some, most, or all connected mechanical drives and axis coordinates when commanded by the machine logic controller 102.

The plasma welding controller 106 can be embodied as hardware, such as a set of circuitry in any form, such as a PLC, or software, such as a set of executable instructions in any form, such as an executable code. The plasma welding controller 106 communicably interfaces with the process master controller 104, the HMI control unit 110, and the data acquisition controller 112. The plasma welding controller 106 acts as commanded via the process master controller 104 to control a set of plasma welding parameters related to a master wire feeding subsystem, an inverter subsystem, a gas control subsystem, a tool cooling subsystem or others, any of which can communicably interface with the plasma welding controller 106.

The process monitoring controller 108 can be embodied as hardware, such as a set of circuitry in any form, such as a PLC, or software, such as a set of executable instructions in any form, such as an executable code. The process monitoring controller 108 communicably interfaces with the process master controller 104. For example, the process monitoring controller 108 can include an image capture device, such as a camera or others, such as a line scanner or others, which can include a laser line scanner or others. For example, the process monitoring controller 108 can include a logic, whether hardware or software, that is configured to enable an observatory automation system, such as Chimera or others, and configured to store data to a memory, whether volatile or non-volatile, such as a data structure, a database, a network drive, or others as part of data logging. For example, the data structure can include an array or others. For example, the database can be relational, in-memory, graphical, or others. For example, the network drive can be of any type direct-attached storage (DAS) or network-attached storage (NAS) on any network, such as a local area network (LAN), a storage area network (SAN), a wide area network (WAN), or others, whether radio, optical, acoustic, wired, wireless, or others. For example, the process monitoring controller 108 can include a thermometer, which can be remote sensing or others, such as a pyrometer or others, such as an infrared (IR) pyrometer or others. The process monitoring controller 108 can handle a request from the process master controller 104 to output data acquired from a process monitoring sensor, such as an IR pyrometer, a laser line scanner, an observatory automation system, or others.

The HMI control unit 110 can be embodied as hardware, such as a set of circuitry in any form, such as a PLC, or software, such as a set of executable instructions in any form, such as an executable code. The HMI control unit 110 communicably interfaces with the machine logic controller 102, the process master controller 104, the plasma welding controller 106, and the data acquisition controller 112. The HMI control unit 110 hosts a machine interface to a material deposition system, such as a touch-display, a peripheral, a control panel, a keyboard, a mobile device, or others. As such, the HMI control unit 110 is configured to command, parameterize, and monitor a machine state and a material deposition parameter, such as a sensor parameter or others. The HMI control unit 110 hosts a server, whether hardware or software, such as an Open Platform Communication (OPC) server, which acts as a data exchange gateway to the machine logic controller 102 and the process master controller 104. For example, such server can communicably interface with (1) a PLC controlling a hardware device and (2) a client, whether hardware or software, hosting a logic configured for an OPC communication, where the server translates between a communication protocol of the PLC and an OPC protocol of the logic. For example, the client uses the server to get data from or send commands to the hardware device through the PLC. Note that the client and the server can be configured in various ways, such as an OPC aggregation technique, an OPC tunneling technique, an OPC bridging technique, an OPC Data Hub technique, or others. Further, note that the server can be configured for data logging and storage by the data acquisition subsystem.

The data acquisition controller 112 can be embodied as hardware, such as a set of circuitry in any form, such as a PLC, or software, such as a set of executable instructions in any form, such as an executable code. The data acquisition controller 112 communicably interfaces with the process master controller 104, the plasma welding controller 106, and the HMI control unit 110. The data acquisition controller 112 is configured to receive a first set of process data from the process master controller 104, a second set of process data from the plasma welding controller 106, a third set of process data from the HMI controller unit 110, and a set of machine data from the HMI control unit 110.

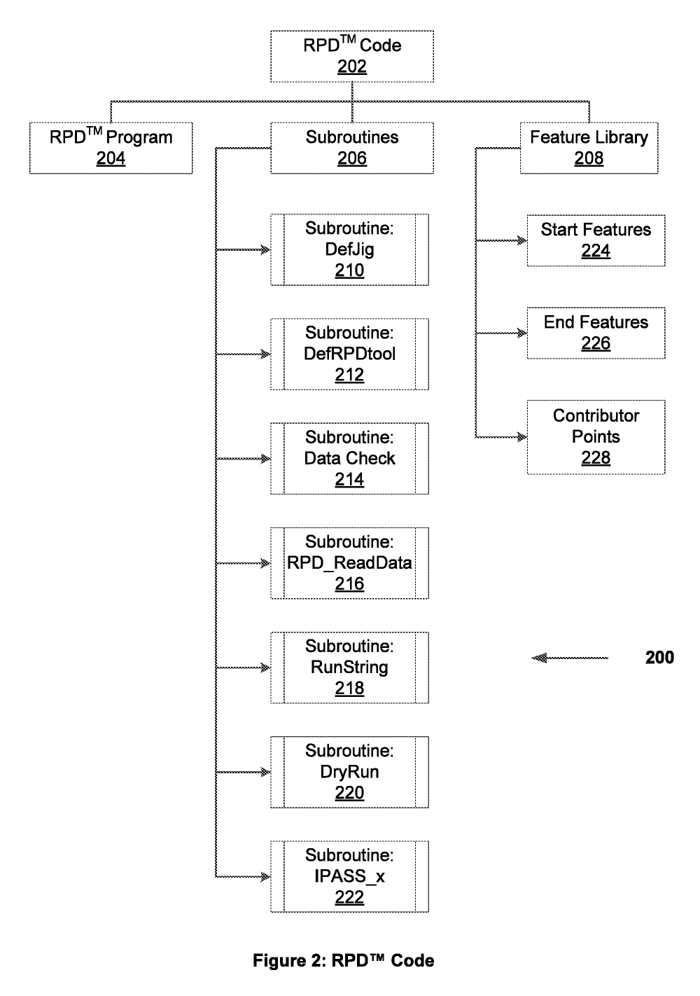

FIG. 2 is a block diagram of an embodiment of a logic architecture according to this disclosure. In particular, a logic architecture 200 includes a code 202 that calls a program 204, a subroutine group 206, and a feature library group 208. The architecture 200 in combination with a robustness of a rapid material deposition process and controlled disturbances from a rapid material deposition machine and a material enables a plurality of repeatable product properties. For example, the controlled disturbances from the rapid material deposition machine can include a wire tension in wire feeding, a wire feed speed accuracy, a deposition trajectory accuracy, a deposition speed accuracy, a deposition atmosphere with respect to water (H₂O) and oxygen dioxide (O₂), a torch plasma gas flow, a main current, a PTA current, a preheat current, or others. For example, the controlled disturbances from the material can include a wire feedstock variation, such as a diameter, a wire straightness, a wire rotation, a wire alloy, a wire density, or others. For example, the controlled disturbances from the material can include a substrate feedstock variation, such as a substrate thickness, a substrate surface roughness, a substrate straightness, or others. The controlled disturbances from the material can include a gas feedstock variation, such as for argon, an H₂O content, an O₂ content, or others.

A configuration consistency across a plurality of rapid material deposition machines during a defined time period is maintained by a standardized calibration to a plurality of specifications of some, most, or all process critical machine elements. For example, the standardized calibration enables control of disturbances from the rapid material deposition machine, as mentioned above. The standardized calibration is a quality assurance (QA) procedure done on a schedule where a machine element, such as a controller, or a result of a material deposition process or a tool use are recorded. For example, such recordation can include a wire speed system parameter. For example, a routine that can be performed periodically, such as every 90 days, can include testing that a specified distance of wire is fed by specified speed during a specified time period. For example, some of the specifications can include a wire speed: a wire feed length variation in a speed mode of −0.3% to +0.3%, or a wire feed length variation in a position mode of −0.3% to +0.3%. While the above-noted variables are unit less, in at least one embodiment, the units are in mm. For example, some, most, or all data structures related to the specifications, such as tables or others, for every subsystem that is calibrated can be provided. For each of the subsystems, this can include a wire tension in a wire feeding, a wire feed speed variation, a deposition trajectory accuracy, a deposition speed accuracy, a deposition atmosphere with respect to H₂O and O₂, a torch plasma gas flow, a main current, a PTA current, a preheat current, or others. For example, some of the process critical machine elements can include a wire tension in a wire feeding, a wire feed speed accuracy, a deposition trajectory accuracy, a deposition speed accuracy, a deposition atmosphere with respect to H₂O and O₂, a torch plasma gas flow, a main current, a PTA current, a preheat current, or others. Furthermore, the above-noted tolerance of variables may vary variable to variable.

A plurality of fed-stock requirements, as mentioned above, are controlled by a receiving inspection and a standardized operation procedure (SOP). For example, the receiving inspection can include a standardized QA process describing how materials are received, checked, stored, or others. For example, an SOP can include a standardized QA process informative of how to insert a material, such as a metal or others, into a rapid material deposition machine, a cleaning of a rapid material deposition machine, on a use of gloves, or others.

The code 202 can be any type of code, such as source code, object code, or others. The code 202 can be standalone code or a part of an application, whether stored in a single locale or distributed among a plurality of locales. The code 202 can call the program 204, the subroutine group 206, or the feature library group 208 in any manner, such as via invoking or others. The code 202 is broken down into a plurality of programs that provide instructions for each workpiece, controlling welding temperature, positioning system and a process of pausing a manufacturing process, such as a welding process, to change a plurality of consumables on a deposition logic, whether hardware or software. The code 202 can communicably interface with a set of rapid plasma deposition recipes and then convert the set of rapid plasma deposition recipes into a set of data that an additive manufacturing machine can use to physically create a rapid plasma deposition form. Note that a rapid plasma deposition recipe from the set of rapid plasma deposition recipes can be a building block of the program 204. The rapid plasma deposition recipes are stored on the plasma welding controller 106. The program 204 calls on each individual recipe by using a numerical identifier, which can be unique.

Note that a process for rapidly depositing a material, such as a metal or others, is controlled via a master controller, such as the process master controller 104, which controls a plurality of set points to a plurality of process input controllers, such as a workpiece traverse speed, a deposition trajectory, a fed-stock rate, a heat input, or others. A plurality of process input variables are controlled following a plurality of trajectories in a Cartesian domain, such as an X, Y, Z space domain, coordinated in real-time, repeated by the program 204 in a fixed deposition schedule. For example, some of the process input variables that are controlled can include a wire tension in a wire feeding, a wire feed speed rate, a deposition speed, a torch plasma gas flow, a main current, a PTA current, a preheat current, a deposition atmosphere with respect to H₂O and O₂, or others. The process for rapidly depositing the material is controlled by the program 204 running on the master controller, which can be without an interaction from a human operator.

The program 204 is developed in a standardized gated work process. The program 204 utilizes a plurality of process monitoring sensors, such as via the process monitoring controller 108, to verify that the process for rapidly depositing the material is kept within a plurality of process windows throughout fabrication in a product development phase. Note that product quality is controlled by material property and geometric shape analysis. When the program 204, a set of process input parameters, and a trajectory schedule are finalized, then the program 204 is release controlled by configuration management. As such, the program 204, as released, can be loaded, such as via a flash drive, to a calibrated machine for rapidly depositing a material, such as a metal or others.

The subroutine group 206 includes a plurality of subroutines, including a Deflig subroutine 210, a DefRPDtool subroutine 212, a Data Check subroutine 214, an RFD_ReadData subroutine 216, a RunString subroutine 218, a DryRun subroutine 220, and an IPASS_x subroutine 222. Note that the subroutine group 206 is not limited to what is shown in FIG. 2 Rather, this configuration can be modified, such as via adding, editing, deleting, or others, for continuous developments of subroutines, feature types, or others. Each member of the subroutine group 206 is further described below. The feature library group 208 includes a plurality of data libraries, including a start features library 224, an end features library 226, and a contributor points library 228. For example, the feature library group 208 is a set of data, such as modules, data structures, or others, where a set of predefined recipe series, which is used to create specific structures on a deposition form, are stored.

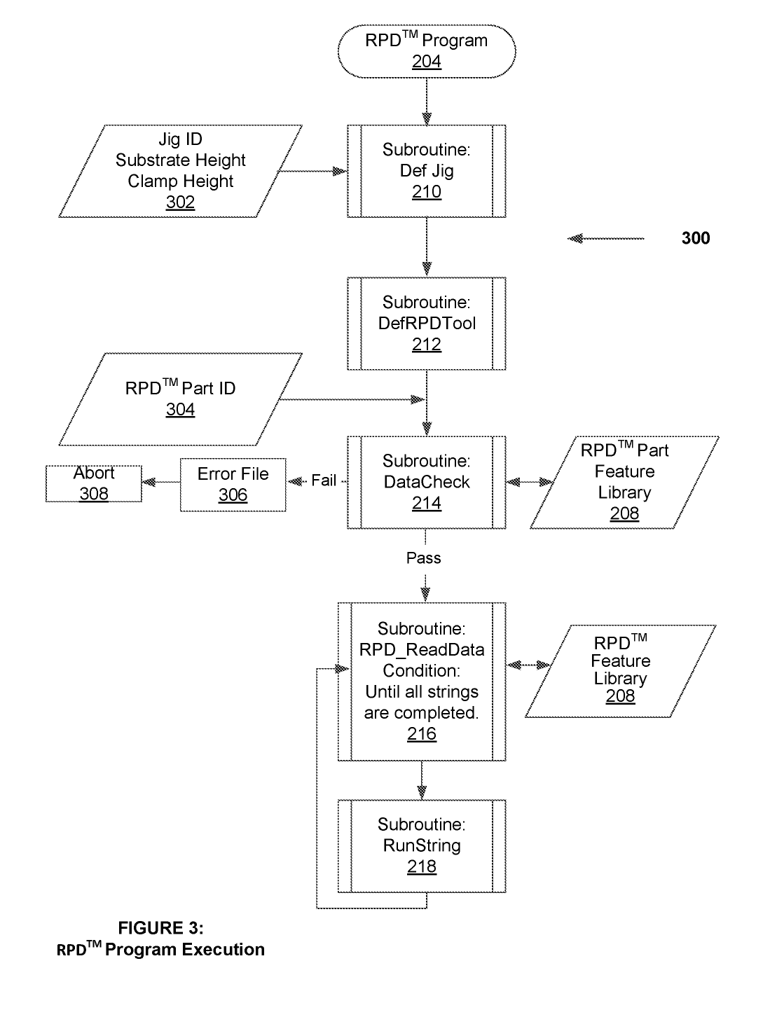

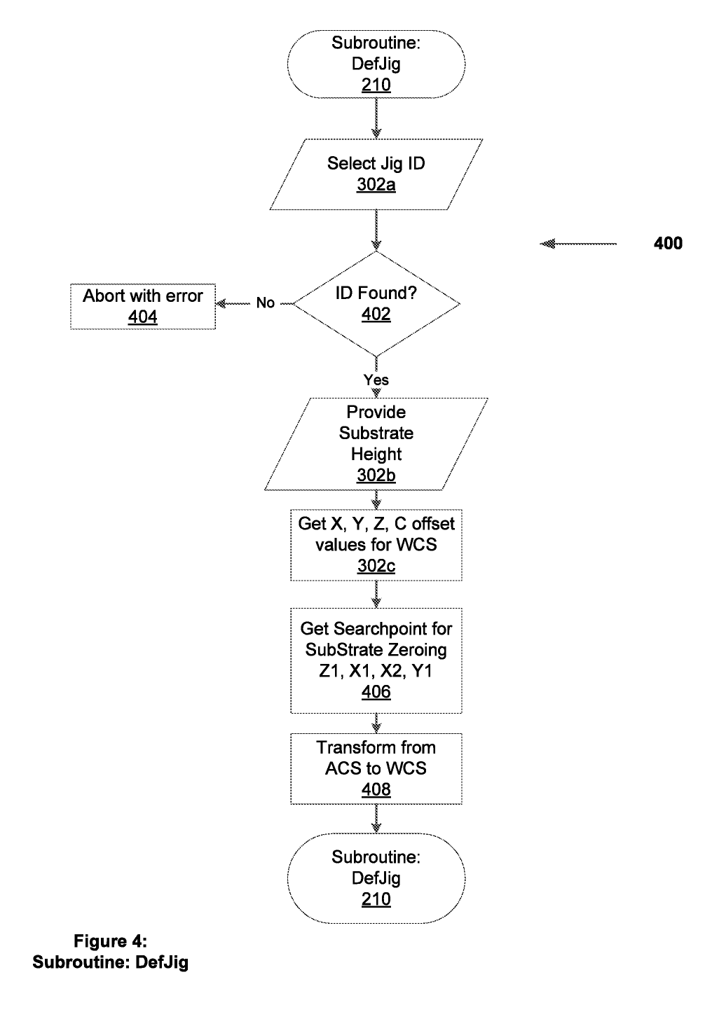

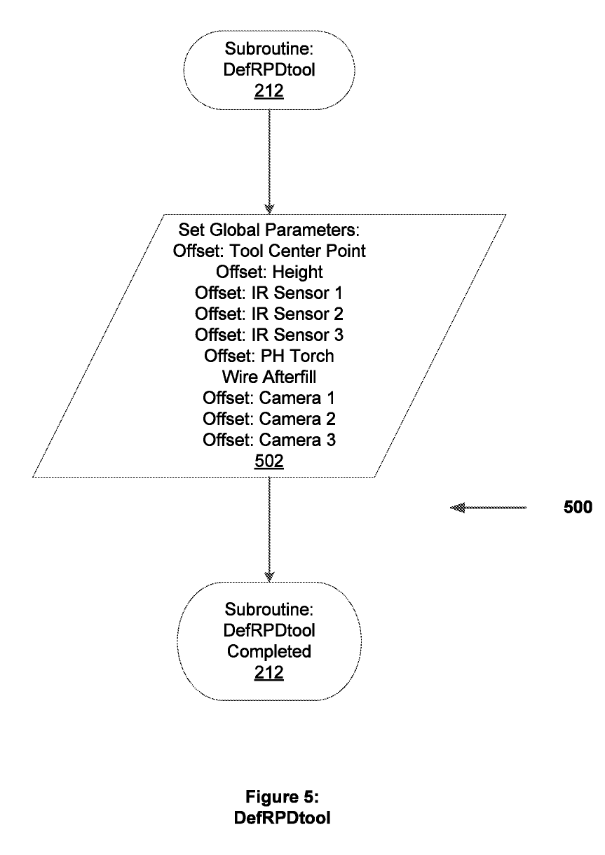

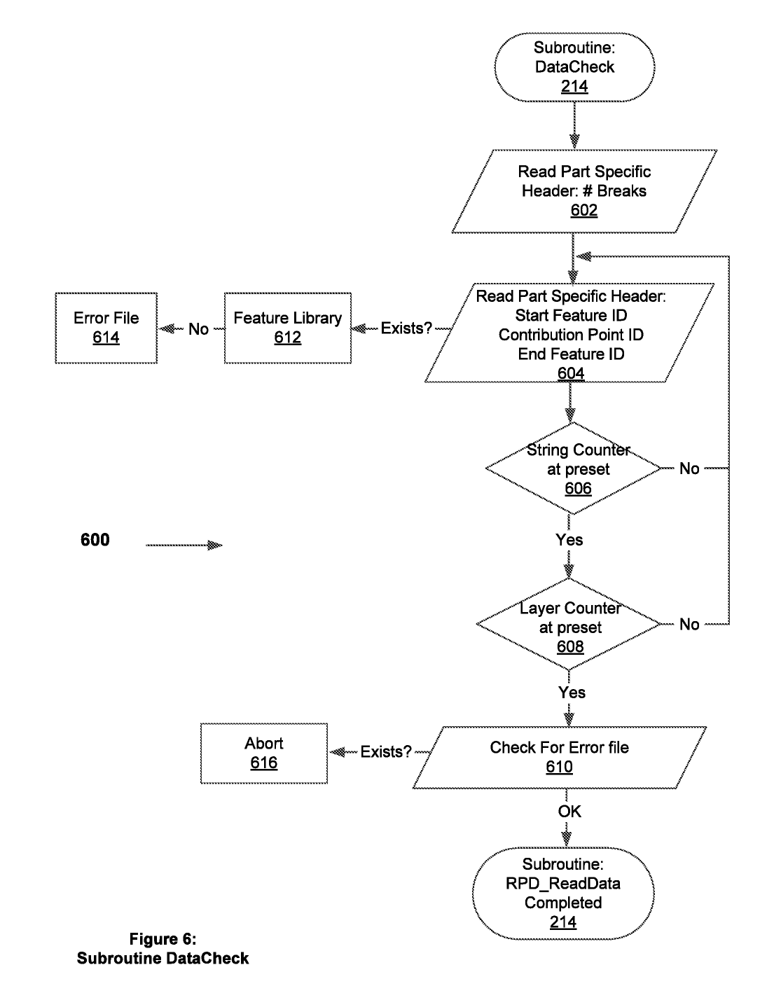

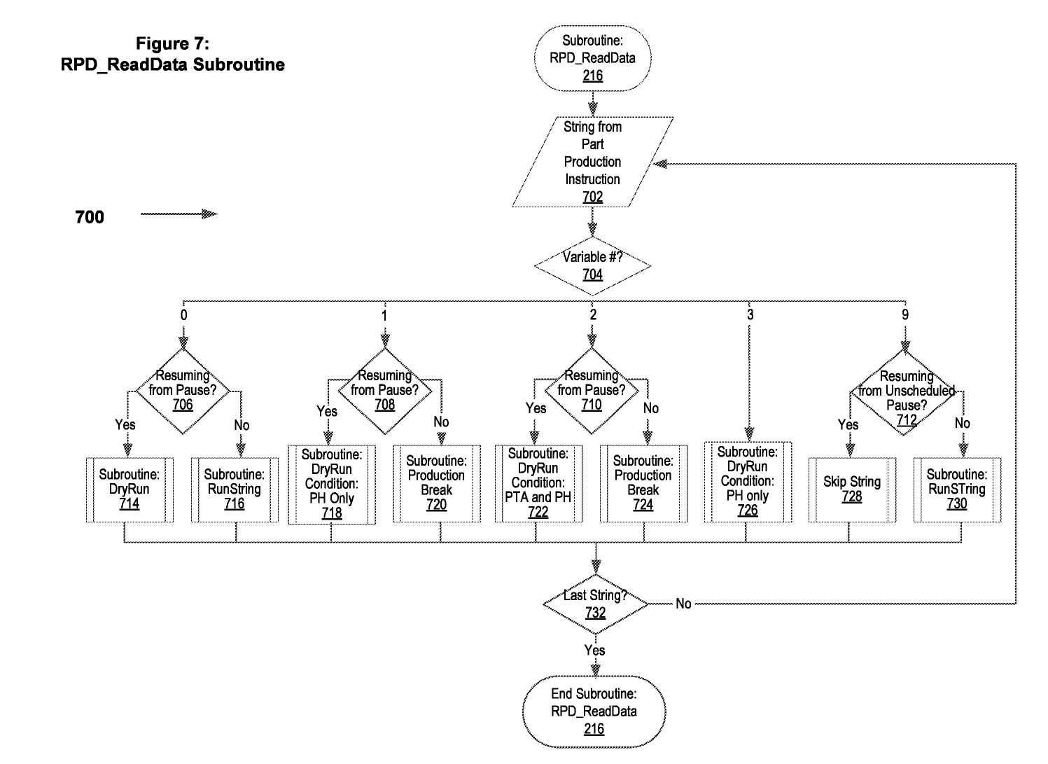

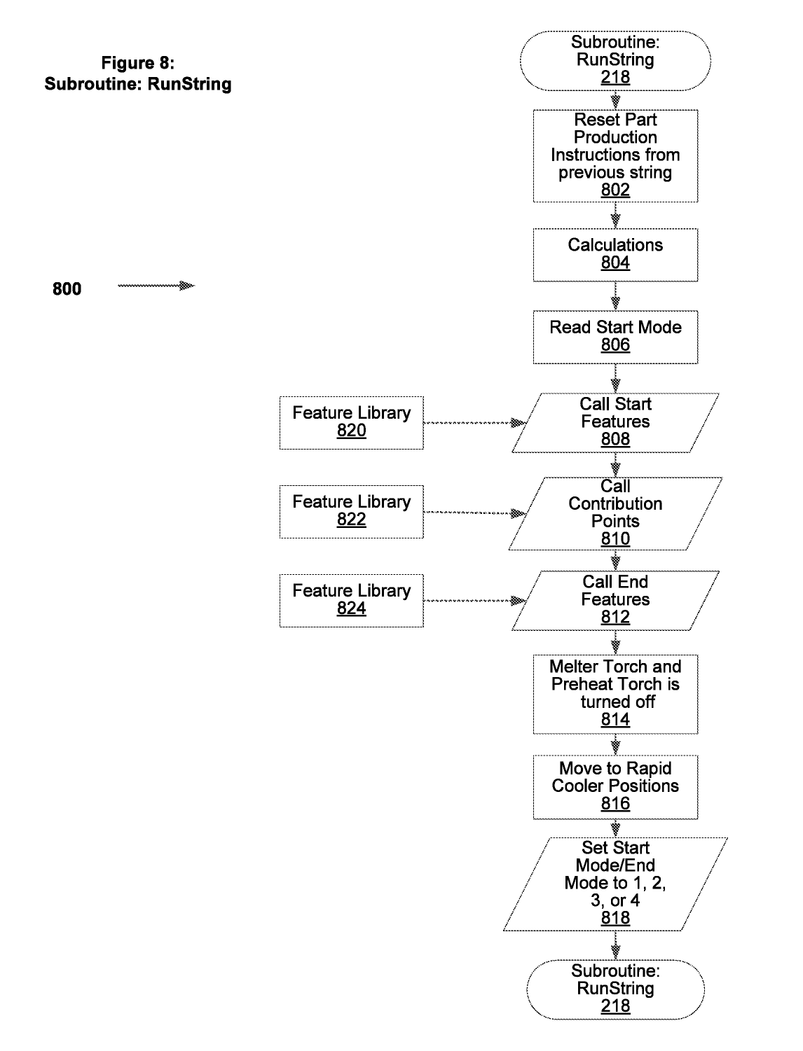

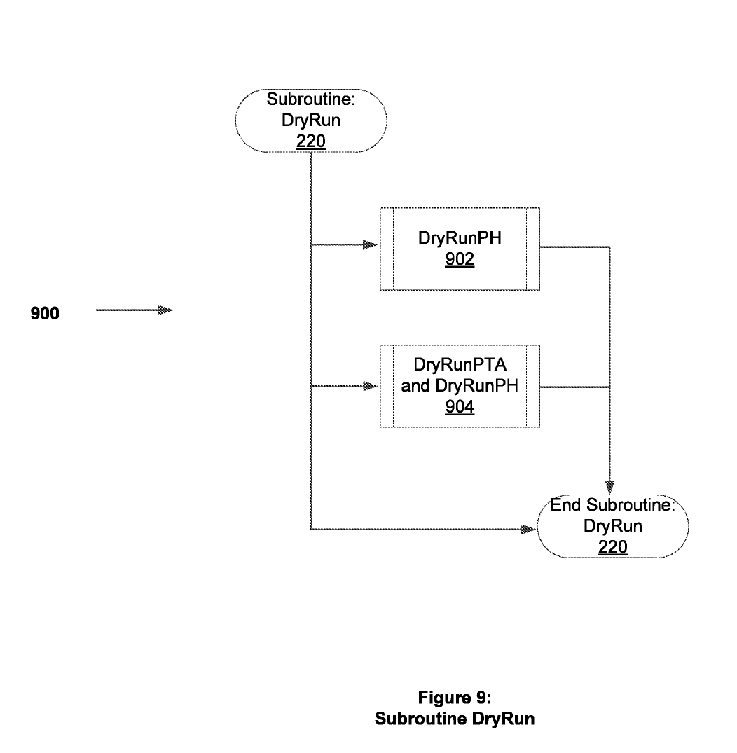

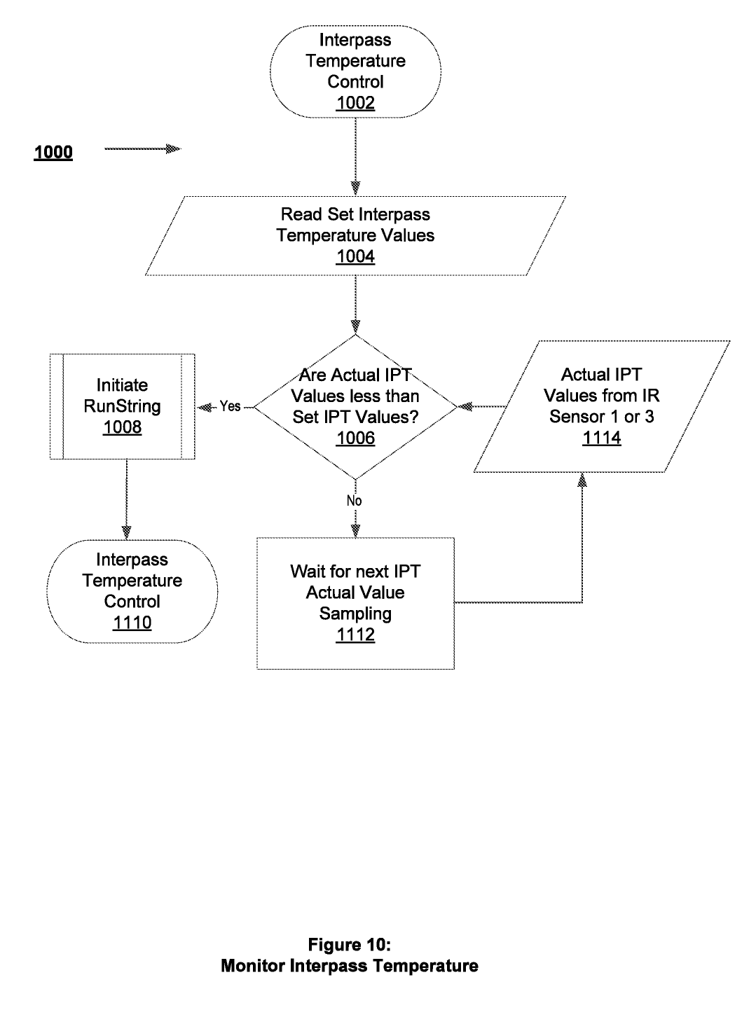

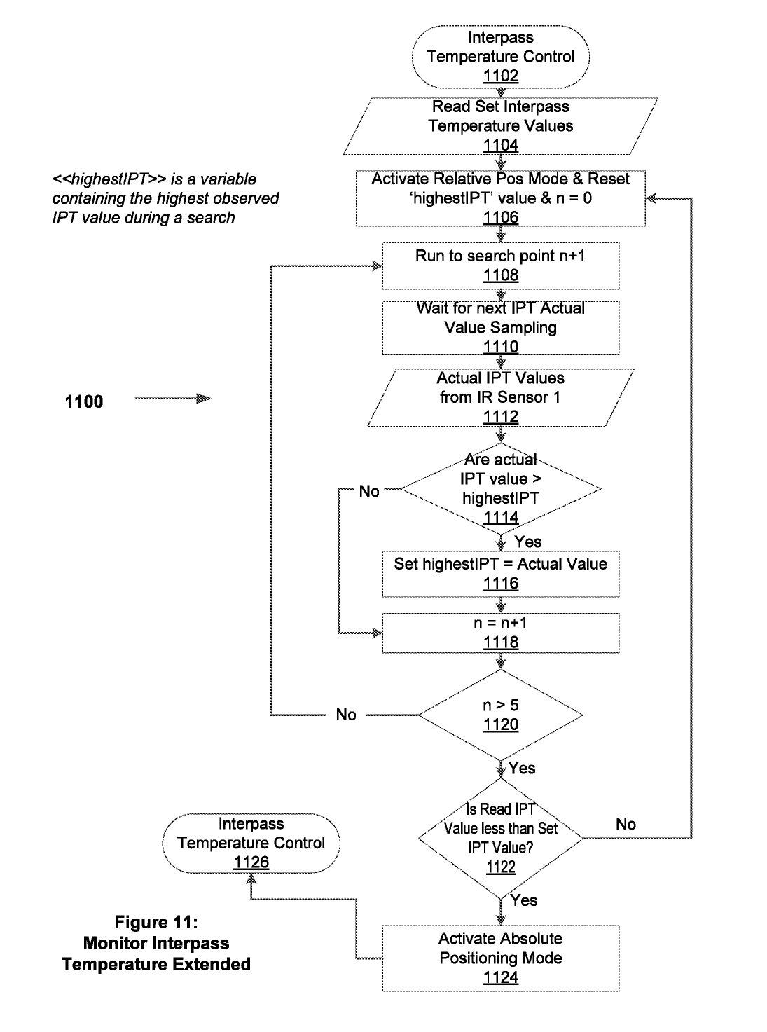

FIG. 3 is a flowchart of an embodiment of a process for executing a logic for additive manufacturing according to this disclosure. FIG. 4 is a flowchart of an embodiment of a define jig function process according to this disclosure. FIG. 5 is a flowchart of an embodiment of a define deposition tool function process according to this disclosure. FIG. 6 is a flowchart of an embodiment of a data check function process according to this disclosure. FIG. 7 is a flowchart of an embodiment of a read data function process according to this disclosure. FIG. 8 is a flowchart of an embodiment of a run string function process according to this disclosure. FIG. 9 is a flowchart of an embodiment of a dry run function process according to this disclosure. FIG. 10 is a flowchart of an embodiment of a temperature process according to this disclosure. FIG. 11 is a flowchart of an embodiment of a temperature process according to this disclosure.

As shown in FIG. 3, a process for additive manufacturing 300 employs the architecture 200 and uses a member of the subroutine group 206 and a member of the feature library group 208. In particular, the code 202, when executed via the process master controller 104, calls the program 204, which is executed via the process master controller 104 and defines a sequence of execution of various rapid plasma deposition process control elements. As such, as per the process 300, the program 204 invokes the subroutine 210, which is further described in FIG. 4, where an operator interfaces with the HMI control unit 110, as per a block 302, to instruct the process master controller 104 about a jig identifier (ID). Further, as per the block 302, the operator interfaces with the HMI control unit 110 to instruct the process master controller 104 about a substrate and a clamping height offset. In the subroutine 210, a relevant workpiece coordinate system for a rapid deposition process at hand is acquired.

Subsequently, as per the process 300, the program 204, as executed via the process master controller 104, invokes the subroutine 212, which is further described in FIG. 5, where the process master controller 104 receives or extracts a set of data about a geometric of a rapid plasma deposition tool, which is a logic, whether hardware or software, for a rapid plasma deposition process at hand and set a tool offset point of the rapid plasma deposition tool at a distance, such as 20.5 millimeters, above a substrate surface. Note that, as per a block 304, the operator interfaces with the HMI control unit 110 to instruct the process master controller 104 on a part ID that should be produced by a rapid plasma deposition machine. For example, the part ID can correspond to a workpiece to be manufactured, as disclosed herein.

Subsequently, as per the process 300, the program 204, as executed via the process master controller 104, invokes the subroutine 214, which is further described in FIG. 6, to gather, receive, or extract a set of rapid plasma deposition part programming instructions and relevant rapid plasma deposition features from the feature library group 208 for the part called by the operator through the HMI control unit 110, as noted above, and verify that some, most, or all information that is needed to complete a rapid plasma deposition process is accessibly available. Note that, as per a block 306 and a block 308, the subroutine 214 aborts the process 300 and stores an error message in a data structure, such as a file, an array, a log, a database, or others, whether local to or remote from the process master controller 104, if there are inputs missing in the code 202, at that point of execution.

Subsequently, as per the process 300, the program 204, as executed via the process master controller 104, invokes the subroutine 216, which is further described in FIG. 7 to read through and verify a set of data gathered by the subroutine 214. The subroutine 216 initiates the subroutine 218, which is further described in FIG. 8, if a set of instructions for a deposit string indicates that the deposit string should be deposited. For example, a deposit string can include a layer of deposited material, such as via a PTA torch melting a wire or others. Then, the subroutine 218 iterates back to the subroutine 216, until all string instructions have been executed.

As mentioned above, FIG. 4 illustrates the subroutine 210, which is used to define a size of a jig being used in a rapid plasma deposition process so that a rapid plasma deposition machine can adjust a workpiece coordinate system to accommodate for different sized jigs. In addition, the subroutine 210 contains a set of search points for a function that enables a substrate zeroing process. The subroutine 210 performs a process 400, some of which has been described above.

In a block 302a, the operator uses the HMI control unit 110 to instruct the process master controller 104 about the size of the jig by providing the jig ID of the jig that will be loaded into the rapid plasma deposition machine. For example, the jig ID can include an alphanumeric string.

In a block 402, the process master controller 104 validates the jig ID, such as via checking the jig ID against a set of IDs, whether in an alphanumeric or another format, which can involve format or type translation therebetween, such as via the process master controller 104.

If the jig ID cannot be validated, then a block 404 is performed, which includes an abort of the subroutine 210 and an output of a content, such as a message is displayed or an alarm is sounded. Otherwise, a block 302b is performed, where the operator uses the HMI control unit 110 to instruct the process master controller 104 about the substrate and clamp height offsets, as described above.

In a block 302c, the process master controller 104 sets the workpiece coordinate system (WCS) according to offsets, as locally retrieved, and adds a substrate height offset to a Z axis.

In a block 406, the process master controller 104 receives search points for a function substrate zeroing (Z1, X1, X2, Y1).

In a block 408, the process master controller 104 transforms an axis system from a Machine Axis Coordinate System (MACS) to the WCS with values provided from the block 302c. Subsequently, the process master controller 104 completes the subroutine 210.

As mentioned above, FIG. 5 illustrates the subroutine 212, which is used to provide a geometric of a rapid plasma deposition tool so that a rapid plasma deposition machine can adjust a process to accommodate for the geometric. The subroutine 212 performs a process 500, some of which has been described above. The process master controller 104 invokes the subroutine 212 once the process master controller 104 receives confirmation that the subroutine 210 is completed.

In a block 502, the subroutine 212 sets a global parameter tool center point offset, a global parameter height offset, a global parameter IR sensor 1 offset, a global parameter IR sensor 2 offset, a global parameter IR sensor 3 offset, a global parameter preheat torch offset, a global parameter wire Afterfill, a global parameter observatory automation system camera, such as a Chimera Camera 1 offset, a global parameter observatory automation system camera, such as a Chimera Camera 2 offset, and a global parameter observatory automation system camera, such as a Chimera Camera 3 offset.

As mentioned above, FIG. 6 illustrates the subroutine 214, which is used to retrieve a set of part programming instructions and relevant features from the library group 208 that the operator called through the HMI control unit 110 and verify that some, most, or all information that is needed to complete the rapid plasma deposition process is available. The subroutine 214 performs a process 600, some of which has been described above. The process master controller 104 invokes the subroutine 214 once the subroutine 212 is completed and the operator has entered the part ID, as per the block 304 of FIG. 3.

In a block 602, the process master controller 104 reads a number of scheduled strings and layers in a part instruction header and writes the part instruction header to a layer and string counter.

In a block 604, the process master controller 104 calls a string start feature ID in the part instruction header from the start features library 224. The process master controller 104 continues onto a block 606 if the start feature library 224 confirms that the string start feature ID is present. Otherwise, as per a block 612 and a block 614, the process master controller 104 aborts the process 600 and reports this error to a data structure, such as a file, an array, a database, or others, if the start features library 224 does not confirm that the string start feature ID is present. Note that in the block 604, the process master controller 104 calls a contributing factor ID in the part instruction header from the start feature library 224. If the start feature library 224 confirms that the contributing factor ID is present, then the block 606 is performed, otherwise, as per the block 612 and the block 614, the process master controller 104 aborts the process 600 and reports this error to a data structure, such as a file, an array, a database, or others. Similarly, the process master controller 104 calls a string end feature ID in the part instruction header from the end feature library 226. If the end features library 226 confirms that the string end feature ID is present, otherwise, as per the block 612 and the block 614, the process master controller 104 aborts the process 600 and reports this error to a data structure, such as a file, an array, a database, or others.

In a block 606, the process master controller 104 checks if a string counter is equal to set value, and if so, then the process master controller 104 increments a layer counter by 1.

In a block 608, the process master controller 104 checks if a layer counter is equal to set value. As such, if layer counter is lower than the set value, then the block 604 is performed, otherwise, a block 610 is performed if the layer counter equals set value. At this point, the process master controller 104 is informed that some, most, or all required information is available. However, if an error file is present after all layers are checked, then the process master controller 104 aborts the process 600 and an output with a content is presented at the HMI control unit 110, such as a message is displayed, an alarm is sounded, or others.

As mentioned above, FIG. 7 illustrates the subroutine 216, which is used to read through and verify some, most, or all information gathered by the subroutine 214. The subroutine 216 performs a process 700, some of which has been described above. The process master controller 104 invokes the subroutine 216 after the subroutine 214 is completed and the operator has entered the part ID, as validated.

In a block 702, the process master controller 104 reads a first string from an part instruction.

In a block 704, the process master controller 104 calls out a variable and a range of parameters that provide instructions to an item on the rapid plasma deposition tool.

As per a set of blocks 706-730, the process master controller 104 initiates the subroutine 218 if the part instruction string calls variable 0. The process master controller 104 initiates the subroutine 220 with a condition of initiating a preheat torch only if the part instruction string calls variable 1 and the program 204 is resuming from a pause state. The process master controller 104 initiates a Break Subroutine if the part instruction string calls variable 1 and the program 204 is not resuming from a pause state. The process master controller 104 initiates the subroutine 220 with a condition of initiating a preheat torch and plasma transfer arch if the part instruction string calls variable 2 and the program 204 is resuming from a pause state. The process master controller 104 initiates the Break Subroutine if the part instruction string calls variable 2 and the program 204 is not resuming from a pause state. The process master controller 104 initiates the subroutine 220 with a condition of initiating a preheat torch only if the part instruction string calls variable 3. The process master controller 104 skips a string if the part instruction string calls variable 9 and the program 204 is resuming from a pause state. The process master controller 104 initiates the subroutine 220 if the part instruction string calls variable 9 and the program is not resuming from a pause state. The process master controller 104 checks whether there are more strings required to complete the part, and if there are no more strings, then subroutine 216 shall terminate.

As mentioned above, FIG. 8 illustrates the subroutine 218, which is used to execute deposition strings that shall be deposited on a substrate according to a set of part programming instructions. The subroutine 218 performs a process 800, some of which has been described above. The process master controller 104 invokes the subroutine 218 if the subroutine 216 has called a proper variable.

In a block 802, the process master controller 104 resets instructions from a previous string. For example, an end mode set during the previous string is a start mode for a new String.

In a block 804 and a block 806, the process master controller 104 calculates a set of positions along the string where a preheat torch, a melter torch, a PTA, a laser line sensor, a set of IR sensors 1, 2, and 3, and a rapid cooler will stop and start.

In a block 808 and a block 820, the process master controller 104 calls a string start feature from the features library 224.

In a block 810 and a block 822, the process master controller 104 calls a set of contribution points from the features library 224.

In a block 812 and a block 824, the process master controller 104 calls a string end features from the features library 224.

In a block 814, the process master controller 104 turns off the preheater torch, the melter torch, and the PTA.

In a block 816, the process master controller 104 moves the preheater torch, the melter torch, and the PTA to a set of rapid cooler positions.

In a block 818, the process master controller 104 sets a start mode for a next string. The process master controller 104 will conduct a regular start if the start mode is set to 1. The process master controller 104 will continue deposition of a string at an end of the string, and a C-axis will adjust a set of coordinates of the next string if the start mode is set to 2. The process master controller 104 will continue deposition of a string at an end of the string, and the C-axis will not adjust a set of coordinates of the next string if the start mode is set to 3. The process master controller 104 will continue deposition in a circular movement at an end of a String and to a beginning of the next string if the start mode is set to 4. Then, the subroutine 218 terminates.

As mentioned above, FIG. 9 illustrates the subroutine 220, which is used to execute a deposition string that shall not be deposited on a substrate according to a set of part programming instructions. For example, the subroutine 220 can enable manufacturing simulation. The subroutine 220 performs a process 900, some of which has been described above. The process master controller 104 invokes the subroutine 220 if the subroutine 216 has called a proper variable.

In a block 902, the process master controller 104 initiates a preheat torch if the subroutine 216 initiates variable 3, or initiates variable 2 and a deposition tool is resuming from a pause mode.

In a block 904, the process master controller 104 initiates a preheat torch and a PTA if the subroutine 216 initiates variable 2 and a deposition tool is resuming from a pause mode. Then, the subroutine 220 terminates.

As mentioned above, FIG. 10 illustrates a temperature process 1000, which can be a subroutine in the subroutines 206 and is used to check a measured interpass temperature value from a set of IR sensors against a set of permitted interpass temperature values in order to ensure quality control during a material deposition process to manufacture a part. The process master controller 104 initiates the process 1000 and can perform the process 1000 when the process master controller 104 receives a string of a set of part-production parameters from the subroutine 218. The process 1000 includes a set of blocks 1002-1114 and is initiated at the block 1002.

In the block 1004, the process master controller 104 reads a set of interpass temperature values.

In the block 1006, the process master controller 104 reads a set of actual interpass temperature values from IR sensor 1 or IR sensor 3, as per the block 1114, and compares the set of actual interpass temperature values against a permitted range defined in the set of interpass temperature values of the block 1004.

In the block 1008, the process master controller 104 initiates the subroutine 218 if the set of actual interpass temperature values are within, such as lower, the permitted range defined in set of interpass values. Note that such comparison can occur on a one-by-one basis, such as comparing one value at a time. Subsequently, the process 1000 terminates. Otherwise, as per the block 1112, the process master controller 104 awaits a next reading of an actual interpass temperature if the values are outside the permitted range defined in the set of interpass values. The process master controller 104 awaits further instructions from the subroutine 218.

As mentioned above, FIG. 11 illustrates a temperature process 1100, which can be a subroutine in the subroutines 206 and is used to check a measured interpass temperature value from an IR Sensor 1 against a permitted interpass temperature values in order to ensure quality control during a material deposition process to manufacture a part. Note that prior to comparing various temperature values, the process 1100 does a search to find a highest temperature in a defined area. The process 1100 includes a set of blocks 1102-1126 and is initiated at the block 1102. The process master controller 104 initiates the process 1100 and can perform the process 1100 when the process master controller 104 receives a string of a part-production parameter from the subroutine 218.

In the block 1104, the process master controller 104 reads a set of interpass temperature values.

In the block 1106, the process master controller 104 activates a relative positioning command in a controller, as disclosed herein. For example, such controller can include the plasma welding controller 106. The process master controller 104 resets a local variable corresponding to a highest interpass temperature. The process master controller 104 resets a search point counter n.

In the block 1108, the process master controller 104 runs a rapid plasma deposition tool to search point n+1.

In the block 1110, the process master controller 104 waits for a next interpass temperature reading from an IR sensor.

In the block 1112, the process master controller 104 reads an actual value from the IR sensor.

In the block 1114, the process master controller 104 compares the value read against the highest interpass temperature value. If the actual value is higher than the highest interpass temperature value, then the process master controller 104 saves a new value to a highest interpass temperature value, as per the block 1116, and then proceeds to the block 1118, otherwise, if the actual value is smaller or equal to the highest interpass temperature value, then the process 1100 proceeds to the block 1118.

In the block 1118, the process master controller 104 adds 1 to the search point counter n.

In the block 1120, the process master controller 104 determines that if the search point counter n is higher than 5, then the process master controller 104 performs the block 1122, otherwise, if the search point counter n is smaller or equal to 5, then the process master controller 104 proceeds to the block 1108.

In the block 1122, the process master controller 104 compares the highest interpass temperature value against the permitted range defined in the set of interpass temperature values. If the highest interpass temperature value is within the permitted range defined in the set of interpass temperature values, then, as per the block 1124, the process master controller 104 activates absolute positioning command to the controller, otherwise, if the highest interpass temperature values are outside the permitted range defined in the set of interpass temperature values, then the process master controller 104 proceeds to the block 1106. The process master controller 104 awaits further instructions from the subroutine 218.

Further, this disclosure discloses a group of functions controlling a logic, whether hardware or software, such as an RPD™ code or others, in such a manner that a syntax can be generated from a form, such as a delimited file, such as a comma separated value (CSV) file, with selected pre-defined features, jobs, coordinates, and other aspects or characteristics, as chosen by a programmer operating a computing device, such as a desktop, a terminal, a tablet, a laptop, a phone, or others. Using the computing device, the programmer can choose a variations of features from a data repository, such as a database, whether stored locally or remotely from the computing device, containing tested and released functions, which can be described in a reference handbook, such as stored in a data structure, such as a file, such as a MS Word file, a Portable Document Format (PDF) file, a Hypertext Markup Language (HTML) file, or others, whether stored local to or remote from the programmer. In addition, the coordinates for a string, such as a start-point and end-point, can be selected and added. Some, most, or all of the coordinates can be read or extracted from a data structure, such as a file, an image, or others, such as a computer aided design (CAD) file, a RPD™ pre-form drawing, or others.

In some embodiments, a template sourced off a productivity document, such as a spreadsheet or others, can be used by the programmer to fill in the features, jobs, coordinates, and other aspects or characteristics, as noted above. In some embodiments, a logic, whether hardware or software, such as an application or others, is created that (1) generates a set of coordinates as read or extracted from a model, such as a sonic model, an RPD preform model, a finished part model, or others, (2) pre-select features according to the model, and (3) generate or present a set of options of a user interface element, such as a drop down menu, a ribbon, or others, for selection of the features, jobs, coordinates, and other aspects or characteristics, as noted above. For example, the set of options can enable an adjustment of a feature, a job, a parameter or any other additive manufacturing characteristic. For example, such logic can enable a selection of a criteria for coordinates, such as a deposition plan, features, jobs, or others, as disclosed herein. In addition, a simulator can be hosted via a computing device, such as a desktop, a terminal, a tablet, a laptop, a phone, or others, or remotely, such as via a remote server or others, where the simulator is configured for simulating a deposition run based on selections and process models, as noted above.

For example, at a beginning phase of a deposition job, the template can be used, such as via running on a computing device, an additive manufacturing system, or others, to check a programming syntax, select a job, determine a set of coordinates for a deposition tool, generate a set of commands, such as a set of numerical control (NC) commands or others, such as a set of G-code commands or others, needed for an additive manufacturing system to run a pre-form data structure, such as an RPD™ pre-form file or others. If any error occurs during syntax check, then the additive manufacturing system aborts and reports to a data structure, such as via writing to a file, a log, a database, or others.

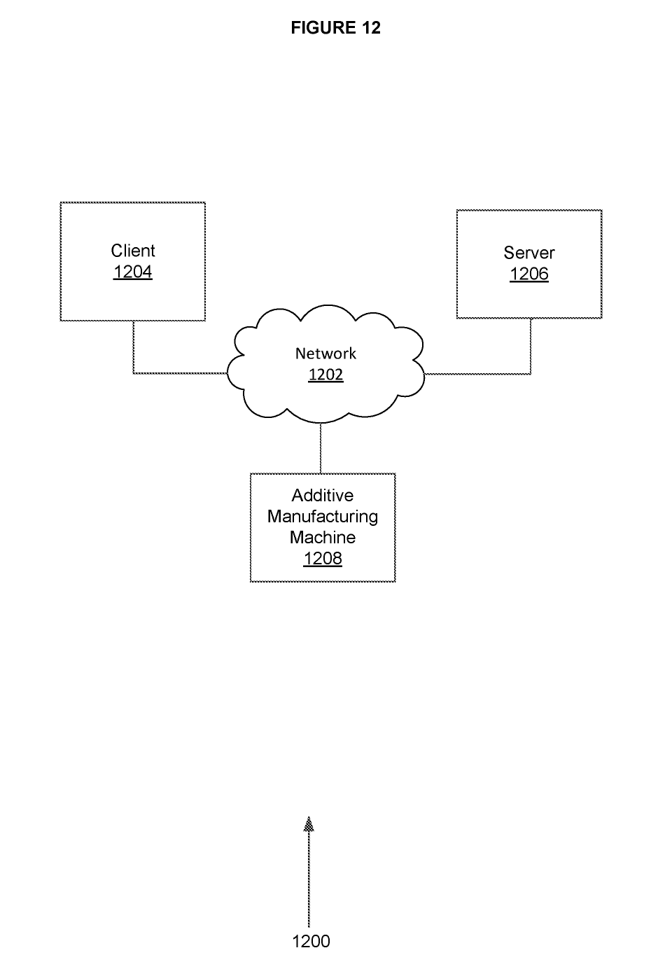

As such, by using the template to program a set of manufacturing instructions, the programmer can save time and reduce a risk of a syntax error, while allowing non-experts to generate the set of manufacturing instructions. This is further described below in FIGS. 12-16.

FIG. 12 shows a diagram of an embodiment of a topology according to this disclosure. A topology 1200 includes a network 1202, a client 1204, a server 1206, and an additive manufacturing machine 1208. The client 1204, the server 1206, and the machine 1208 are in signal communication with the network 1202. For example, the network 1202 can include a LAN, a WAN, or others, whether wired, wireless, waveguide, or others. For example, the client 1204 can include a terminal, a desktop, a laptop, a tablet, a phone, or others, where the client 1204 hosts an application on an operating system (OS) running on the client 1204. For example, the application can include a productivity application, such as a spreadsheet or others, a browser, a mobile app, or others. For example, the OS can include Windows, Linux, or others. Similarly, the server 1206 can include a multicore processor running an OS and hosting an application on the OS. For example, the OS can include Windows, Linux, or others. The application can include an OPC logic. Likewise, the machine 1208 can include a metal deposition machine or others. Note that the client 1204, the server 1206, and the machine 1208 can be located in a same locale or different locales.

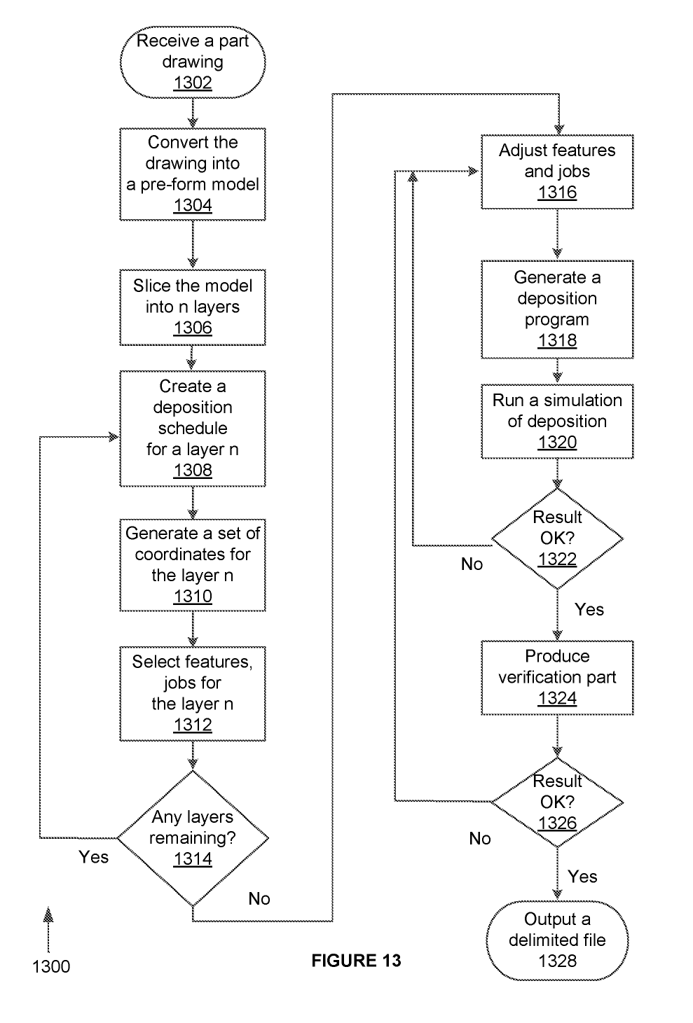

FIG. 13 shows a flowchart of an embodiment of a process for generating a delimited file according to this disclosure. A process 1300 includes a plurality of blocks 1302-1328. The process 1300 can be performed via the topology 1200. The process 1300 can enable a conversion of a workpiece drawing into a deposition program, have an option to simulate a deposition run based on the deposition program, and load the deposition program to any given production machine for a verification run and a production (upon approved verification parts).

In the block 1302, a computing device, such as the client 1206 or others, receive a drawing of a workpiece, such as a part. For example, such receiving can be via downloading the drawing over the network 1202, or others. For example, such receiving can be via accessing the drawing on a flash drive in communication with the computing device, or others. For example, the drawing can be included in a data structure, such as a file, a database record, or others. For example, the drawing can be an image, such as 3-dimensional or others. For example, the file can be a CAD file.

In the block 1304, the computing device converts the drawing into a pre-form model. For example, the pre-form model includes a model that a deposition program will be using to generate a set of coordinates for a deposition schedule.

In the block 1306, the computing device slices the pre-form model into a plurality of layers according to a possible layer thickness given by a deposition process, as disclosed herein. Such slicing process will provide a number of layers as an input to the deposition program. For example, the layers can extend along a horizontal plane, as vertically stacked on each other.

In the block 1308, after the number of layers is determined, the computing device creates a deposition schedule, layer by layer, for a layer of the layers. For example, the deposition schedule can include a deposition path for a layer of the layers. For example, a layer of the layers can be divided into a plurality of strings which define a deposition path. For example, the strings can include a start string and an end string.

In the block 1310, when the deposition schedule is determined, the computing device generates a set of start coordinates and a set of end coordinates for each string found in the deposition schedule, as per the block 1308. Each of the set of start coordinates and the set of end coordinates includes a set of coordinates on a plane, such as a Cartesian plane, such as an X-plane and a Y-plane, along a deposition plane.

In the block 1312, after the set of start coordinates and the set of end coordinates for each string found in the deposition schedule is generated, the computing device selects a start feature, an end feature, and a process feature, such as sourced from a feature library, as disclosed herein. This selection is based on a content of the feature library and workpiece layout, such as a single bead string, a cross-section, a radius fill, or others. This selection can later in the process 1300 be adjusted on-demand or if needed to more suitable features, such as responsive to a user input into the computing device.

In the block 1314, the computing device decides whether any layers are remaining that have not been analyzed as per the block 1310 and the block 1312. If any layers are remaining, then the process 1300 iterates back to the block 1308. If no layers are remaining, then the block 1316 is performed.

In the block 1316, the computing device adjusts a feature or a job for the pre-form model, such as for a layer, whether based on a rule, a heuristic, an algorithm, a pattern, or others, whether based on an input from the programmer operating the computing device.

In the block 1318, the computing device generates a deposition program or another form of instructions. For example, the computing device validates or approves the deposition program and outputs the deposition program in a delimited format, such as a CSV format or others, such that the deposition program, in the delimited format, can be produced on a calibrated deposition machine.

In the block 1320, the computing device runs a simulation of deposition based on the deposition program. The simulation is run in a simulator, whether hosted local to or remote from the computing device. The simulation simulates a build-up of a deposition according to the values, as noted above.

In the block 1322, the computing device decides whether a result of the simulation is acceptable, whether based on an input from the programmer operating the computing device or based on a rule, a heuristic, an algorithm, a pattern, or others, whether stored local to or remote from the computing device. If the result of the simulation is not acceptable, then the process 1300 iterates to the block 1316, such as in order for the programmer to manually adjust according to the result of the simulation, generate an updated deposition program and re-run the simulation. If the result of the simulation is acceptable, then the block 1324 is performed.

In the block 1324, the computing device communicates with an additive manufacturing system, such as the machine 1208 over the network 1202, to request a production of a verification workpiece, such as a part as depicted in the drawing of the block 1302. For example, the request can include the deposition program or grant access to the deposition program such that the machine 1208 can run or access the deposition program for verification of the part.

In the block 1326, the computing device determines if the verification workpiece meets a set of standards. For example, the computing device can receive a set of inputs from the programmer, such as via a display, a camera, a microphone, a cursor device, a keyboard, whether physical or virtual, or others, or capture imagery of the verification workpiece, perform object recognition or analytics on the imagery, generate a set of values based on such performance, and compare the set of values against a set of standard values, which can be updatable, including automatically. Note that imagery is an example and other forms of input are possible, such as acoustics, lasers, or others. If the verification workpiece meets the set of standards, then the block 1328 is performed. If the verification workpiece does not meet the set of standards, then the process 1300 iterates to the block 1316, such as if verification fails, then the programmer can adjust according to what does not comply with the set of standards, generate an updated deposition program, and produce a new verification part.

In the block 1328, when the verification satisfies the set of standards of the block 1326, the computing device outputs an approved deposition program, which may be in a delimited format, such as a CSV file or others. Note that the verification part is also produced on a calibrated deposition machine. As such, the code is generated in the block 1318, tested in the block 1320, and verified in the blocks 1324-1326.

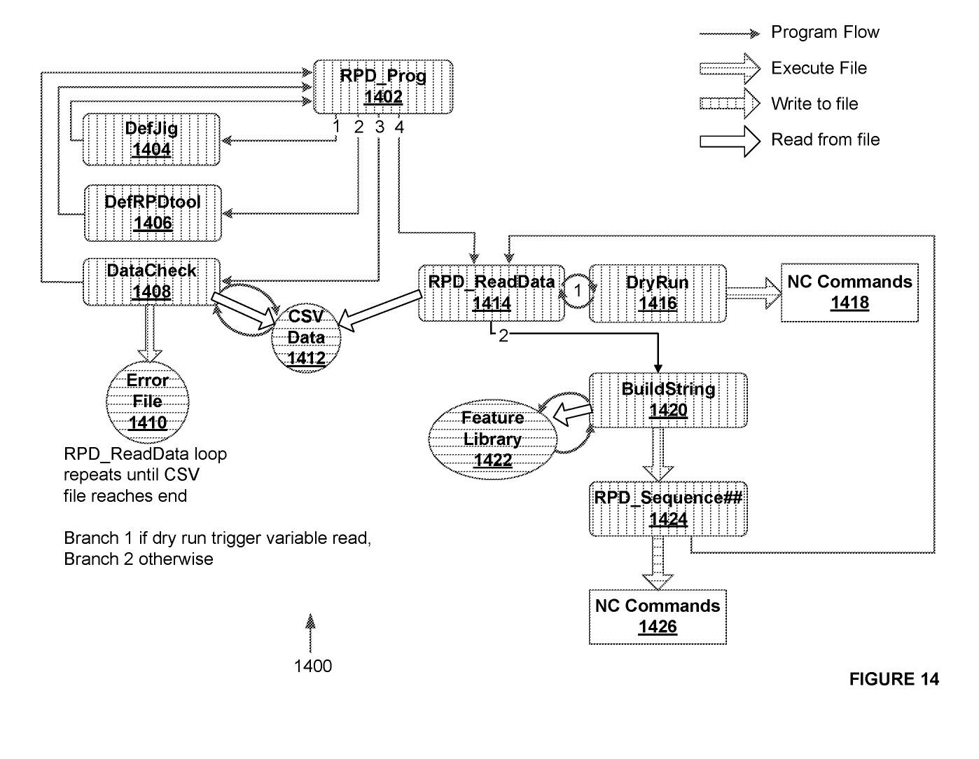

FIG. 14 shows a diagram of an embodiment of an additive manufacturing process according to this disclosure. In particular, a process 1400 includes a plurality of blocks 1402-1426, which can be performed via the topology 1200. The process 1400 contains a plurality of function calls made to a plurality of functions, such as a program code or others, which combined simplifies a programming effort for an additive material deposition. The functions are prepared for at least three different user groups: a programmer group, a feature developer group, and a developer group. This form of access control can be enforced via passwords, biometrics, or others, such as via the server 1206 over the network 1202, where a particular user group is associated to a set of data via a flag associated with or included in the set of data.

The programmer group is enabled to enter coordinates for start and stop of strings, set values for temperature limits for manufacturing process, select start-, end-, and contribution features, select predefined recipes for process jobs, and select dry run routines. The feature developer group includes all features of the programmer group and adds a development of features and a development of recipes access control. The developer group includes all features of the feature developer group and adds developing/debugging of a template code.

The template can be a visual basic for applications (VBA) project for a spreadsheet worksheet, which generates a data table according to input from a programmer, such as based on the programmer group, or getting data from the block 1318 of FIG. 3. The VBA project can be hosted on the client 1204 or a standalone computing device. The template provides feedback in a form of plots based on position input, 3D-map of a workpiece and estimated part run time. Upon saving the finished template on the client 1204 or onto the server 1206, an error check can be executed. This error check is designed to catch invalid parameters that would cause syntax errors or parameters outside a predefined value range that might cause unwanted program behavior. If no errors are detected, such as via the client 1204 or the server 1206, then the worksheet is formatted as a delimited file, such as a CSV file or others, and key program parameters are compiled and inserted into a header line or a row of the delimited file.

The block 1402 corresponds to a logic that controls a sequence of execution of the functions, as disclosed herein. For example, the logic includes a function RPD_Prog that controls calling sub-functions, such as Deffig, DefRPDTool, DataCheck, or others, sequentially according to a machine state. The RPD_Prog reads out a program ID from the computing device. This ID includes a set of values, such as a jig number, a substrate height, a clamp height, a program ID, or others.

The block 1404 corresponds to the logic of the block 1402 calling a sub-function Deffig. In this function, a pre-defined set of unique jig data are processed, which can include storage. The jig data includes a set of values, such as a set of transition coordinates for a workpiece coordinate system (WCS), a set of travel data limitations, such as acceleration, maximum speed, or others.

The block 1406 corresponds to the logic of the block 1402 calling a sub-function DefRPDtool when a WCS transition is done. This sub-function enables machine unique offsets for a tool geometry, such as a set of machine settings according to commissioning, calibration records or others, to be stored. This sub-function ensures a possibility, together with the calibration records, to run a same deposition program across a variation of deposition machines.

The block 1408 corresponds to the logic of the block 1402 calling a sub-function DataCheck after a deposition machine is set up with a set of correct WCS coordinates and tool coordinates. The sub-function DataCheck checks a syntax of a deposition program. The function reads a set of header lines in a delimited file, such as a set of CSV header lines, where key program parameters are stored by a save function, as per the block 1412. Parameters detailing program pauses are stored in the computing device. The sub-function DataCheck verifies that some, most, or all features to be called by part program exist in a file system, whether local to or remote from the computing device. If a feature is missing, then the deposition program is aborted and an error message detailing missing feature(s) is written to a machine interface, such as to a data structure, such as a file, a database record, or others, as per the block 1410.

The block 1414 corresponds to the logic 1402 calling a sub-function RPD_ReadData at a termination of the sub-function DataCheck without any errors. The sub-function RPD_ReadData reads the delimited file, such as a CSV file, one line at a time, and stores values to predefined program variables. If a dry run is programmed, then the sub-function RPD_ReadData catches this from certain trigger variables in a current delimited file line. Special dry run subroutines are executed based on which trigger variable was received. RPD_ReadData transfers parameters detailing positions and currents to the selected dry run routine, as per the block 1416, which executes a set of NC commands. If no dry run trigger variable is caught, then the current string is interpreted as a normal string and a sub-function BuildString is called by the sub-function RPD_ReadData, as per the block 1420. The sub-function BuildString searches some, most, or all existing RPD_Sequence logic, such as a function, an object, a data structure, or others, for one matching current combination of features, as per the block 1422. If a current combination of features has already been encountered by the deposition program, then this deposition sequence is executed. If no such sequence exists, then the sub-function BuildString creates and writes to a new file RPD_Sequence## (incrementing sequence number), as per the block 1424. Each deposition sequence includes a predefined set of NC commands followed by a copy of called features. Upon start of the deposition program, some, most, or all deposition sequences from a previous run can be deleted.

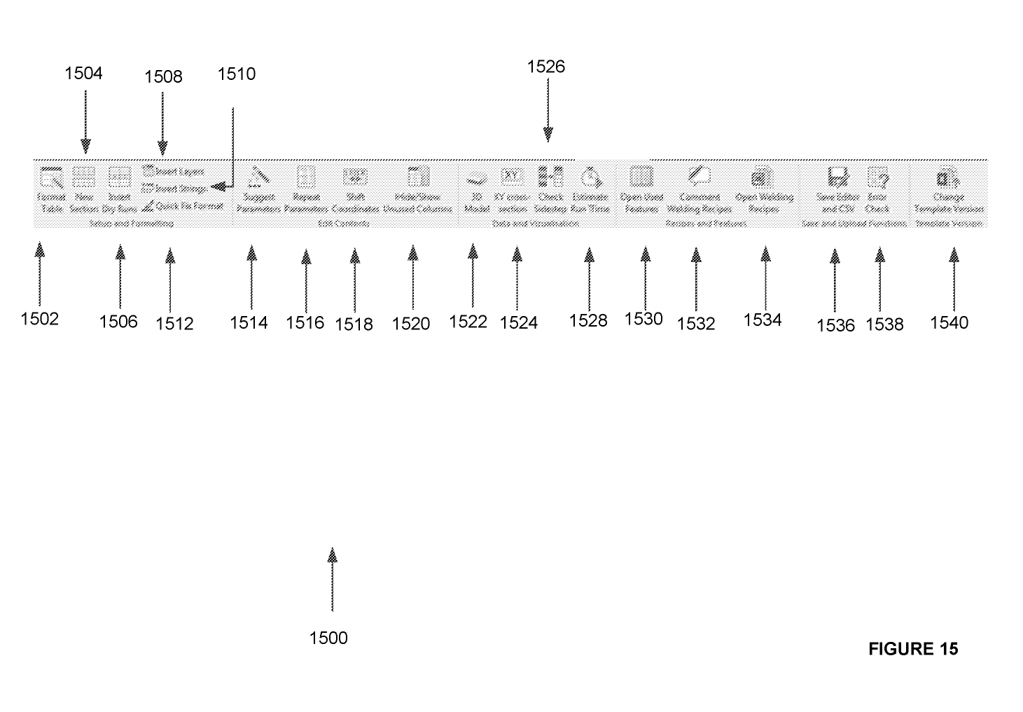

FIG. 15 shows a screenshot of an embodiment of a menu according to this disclosure. In particular, the process 1400 employs a set of pre-defined functions to support a programmer in generating a deposition program. The set of pre-defined functions can be called via a menu 1500, which has a set of icons 1502-1540, which are positioned in a set of defined areas: a setup and formatting area, an edit content area, a data and visualization area, a recipes and features area, a save and upload functions area, and a template version area.

The setup and formatting area includes a format table icon 1502 which, upon activation, enables a programmer to input basic part information, such as a layer count, a string count per layer, a layer height difference, an initial number of dry runs, or others. Note that a corresponding table form is formatted accordingly.

The setup and formatting area includes a new section icon 1504 which, upon activation, enables a programmer to insert a layers with different number of strings.

The setup and formatting area includes an insert dry runs icon 1506, which upon activation, enables a programmer to insert a dry run string.

The setup and formatting area includes an insert layer icon 1508, which upon activation, enables a programmer to insert a single layer.

The setup and formatting area includes an insert string icon 1510, which upon activation, enables a programmer to insert a string into a layer.

The setup and formatting area includes a quick fix format icon 1512, which upon activation, enables a programmer to reset a color scheme, a comment and a cell size.

The edit contents area includes a suggest parameter icon 1514, which upon activation, enables calculation of a baseline parameter based on already filled in string positions.

The edit contents area includes a repeat parameter icon 1516, which upon activation, enables copying of a parameters from a layer (selected by programmer input) to other layer(s).

The edit contents area includes a shift coordinates icon 1518, which upon activation, enables shifting or rotating coordinates for either entire part, single layers, or single strings, which can change a length of a string.

The edit contents area includes a hide/show unused columns icon 1520, which upon activation, enables toggling the visibility of unused columns.

The data and visualization area includes a 3D model icon 1522, which upon activation, enables drawing a simple height map of part based on input coordinates and height step.

The data and visualization area includes a XY cross-section icon 1524, which upon activation, enables plotting string coordinates for a selected layer.

The data and visualization area includes a check sidestep icon 1526, which, upon activation, enables calculation of distance between string start/end points (shortest normal distance between strings).

The data and visualization area includes an estimate run time 1528, which, upon activation, enables calculation of an estimate of deposition time based on traverse speed, string lengths, and set interpass temperatures.

The recipes and features area includes an open used features icon 1530, which, upon activation, enables opening some, most, or all unique features called in program in text editor.

The recipes and features area includes a comment welding recipes icon 1532, which, upon activation, enables adding comment with welding recipe info (currents, plasma gas, wire feed etc.) to selected recipes.

The recipes and features area includes an open welding recipes icon 1534, which, upon activation, enables opening a worksheet with overview of some, most, or all welding recipes.

The save and upload functions area includes a save editor and CSV icon 1536, which, upon activation, enables running an error check to verify program parameters, formats key parameters to CSV header lines, formats rest of program and saves as separate worksheet, to be re-saved as CSV file for program upload.

The save and upload functions area includes an error check icon 1538, which, upon activation, enables running same error check as a save function.

The template version area includes a change template version icon 1540, which, upon activation, sets a template version.

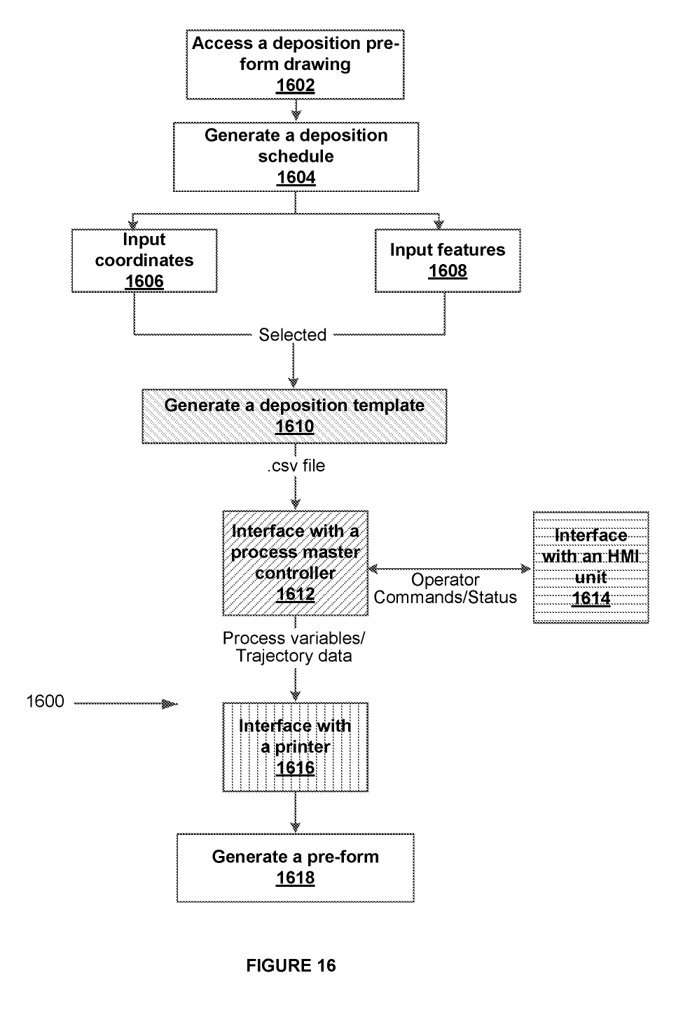

FIG. 16 shows a diagram of an embodiment of a process of using a PLC with a delimited file according to this disclosure. In particular, a process 1600 includes a plurality of blocks 1602-1618, which are performed via the schema 100 and the topology 1200. The process 1600 starts with an access of a pre-form drawing, as per the block 1602, from which a programmer can choose, such as via inputting values into the computing device, a deposition schedule, a set of coordinates and a set of features, as per the blocks 1604-1608. Such data is then entered into a logic, such as an application or others, running on the computing device such that the logic generates a deposition template. Upon an input from the programmer or from another logic, the computing device converts the deposition template into a delimited file, such as a CSV file or others, which is loaded onto a process master controller, such as via a network download, a flash drive, or others. Upon a receipt of a command from an operator, the process master controller starts the deposition program, generating NC commands (as per FIG. 14) for a deposition printer to use. The output of the printer is a deposition pre form.

Various embodiments of this disclosure can be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters can also be coupled to the system to enable the data processing system to become coupled to other data processing systems or remote printers or storage devices through intervening private or public networks. Modems, cable modems, and Ethernet cards are just a few of the available types of network adapters.

This disclosure can be embodied in a system, a method, and/or a computer program product. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, among others. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a LAN or a WAN, or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of this disclosure.

Aspects of this disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of this disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide a reader through the description of the methods. Although process flow diagrams can describe the operations as a sequential process, many of the operations can be performed in parallel or concurrently. In addition, the order of the operations can be re-arranged. A process can correspond to a method, a function, a procedure, a subroutine, a subprogram, etc. When a process corresponds to a function, its termination can correspond to a return of the function to the calling function or the main function.

Features or functionality described with respect to certain embodiments can be combined and sub-combined in and/or with various other embodiments. Also, different aspects and/or elements of embodiments, as disclosed herein, can be combined and sub-combined in a similar manner as well. Further, some embodiments, whether individually and/or collectively, can be components of a larger system, wherein other procedures can take precedence over and/or otherwise modify their application. Additionally, a number of steps can be required before, after, and/or concurrently with embodiments, as disclosed herein. Note that any and/or all methods and/or processes, at least as disclosed herein, can be at least partially performed via at least one entity or actor in any manner.

The terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of this disclosure.

The terminology used herein is for describing particular embodiments and is not intended to be necessarily limiting of this disclosure. As used herein, the singular forms “a,” “an” and “the” are intended to include the plural forms as well, unless the context clearly indicates otherwise. Also, as used herein, the term “a” and/or “an” shall mean “one or more,” even though the phrase “one or more” is also used herein. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof. Furthermore, when this disclosure states herein that something is “based on” something else, then such statement refers to a basis which can be based on one or more other things as well. In other words, unless expressly indicated otherwise, as used herein “based on” inclusively means “based at least in part on” or “based at least partially on.”

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Unless otherwise defined, all terms (including technical and scientific terms) used herein have same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

As used herein, the term “about” and/or “substantially” refers to a +/−10% variation from the nominal value/term. Such variation is always included in any given.

If any disclosures are incorporated herein by reference and such disclosures conflict in part and/or in whole with this disclosure, then to an extent of conflict, and/or broader disclosure, and/or broader definition of terms, this disclosure controls. If such disclosures conflict in part and/or in whole with one another, then to an extent of conflict, the later-dated disclosure controls.

It will be apparent to skilled artisans that various modifications and variation can be made in this disclosure without departing from a spirit or scope thereof. Thus, it is intended that this disclosure cover modifications and variations thereof, provided that such modifications and the variations come within a scope of the claims, as recited below, and their equivalents.

What is claimed is:

1. A method comprising:
converting, by a processor, a drawing into a model;
slicing, by the processor, the model into a plurality of layers;
creating, by the processor, a plurality of deposition schedules for the layers, wherein the deposition schedules one-to-one correspond to the layers;
generating, by the processor, a plurality of coordinate sets for the layers, wherein the coordinate sets one-to-one correspond to the layers, wherein each of the coordinate sets includes a set of start coordinates and a set of end coordinates;
selecting, by the processor, a plurality of features from a library for the layers;
generating, by the processor, a program based on the features;
outputting, by the processor, the program in a delimited format;
running, by the processor, a simulation of a deposition based on the program in the delimited format;
determining, by the processor, whether a result of the simulation is acceptable based on a parameter; and
requesting, by the processor, an additive manufacturing machine to product a workpiece responsive to the result being acceptable based on the parameter, wherein the workpiece is depicted in the drawing.

2. The method of claim 1, further comprising:
requesting, by the processor, a camera to capture an image of the workpiece;
performing, by the processor, an object recognition process on the image;
generating, by the processor, a first set of values based on the object recognition process; and
comparing, by the processor, the first set of values against a second set of values such that a compliance of the workpiece to the second set of values is determined.

3. The method of claim 2, wherein the second set of values is based on a set of inputs from a user.

4. The method of claim 2, further comprising:
outputting, by the processor, the program to a computing device.

5. The method of claim 4, wherein the program is in the delimited format when output to the computing device.

6. The method of claim 1, further comprising:
forming, by the processor, an acoustic representation of the workpiece;
performing, by the processor, an object recognition process on the acoustic representation;
generating, by the processor, a first set of values based on the object recognition process; and
comparing, by the processor, the first set of values against a second set of values such that a compliance of the workpiece to the second set of values is determined.

7. The method of claim 6, wherein the second set of values is based on a set of inputs from a user.

8. The method of claim 6, further comprising:
outputting, by the processor, the program to a computing device.

9. The method of claim 8, wherein the program is in the delimited format when output to the computing device.

10. The method of claim 1, further comprising:
forming, by the processor, a laser representation of the workpiece;
performing, by the processor, an object recognition process on the laser representation;
generating, by the processor, a first set of values based on the object recognition process; and
comparing, by the processor, the first set of values against a second set of values such that a compliance of the workpiece to the second set of values is determined.

11. The method of claim 10, wherein the second set of values is based on a set of inputs from a user.

12. The method of claim 10, further comprising:
outputting, by the processor, the program to a computing device.

13. The method of claim 12, wherein the program is in the delimited format when output to the computing device.

14. The method of claim 1, wherein the creating, the generating, and the selecting is consecutively and iteratively performed on a layer-by-layer basis.

15. A system comprising:
a processor; and
a memory storing a set of instructions that are executable by the processor, wherein the set of instructions instructs the processor to:
convert a drawing into a model;
slice the model into a plurality of layers;
create a plurality of deposition schedules for the layers, wherein the deposition schedules one-to-one correspond to the layers;
generate a plurality of coordinate sets for the layers, wherein the coordinate sets one-to-one correspond to the layers, wherein each of the coordinate sets includes a set of start coordinates and a set of end coordinates;
select a plurality of features from a library for the layers;
generate a program based on the features;
output the program in a delimited format;
run a simulation of a deposition based on the program in the delimited format;
determine whether a result of the simulation is acceptable based on a parameter; and
request an additive manufacturing machine to product a workpiece responsive to the result being acceptable based on the parameter, wherein the workpiece is depicted in the drawing.

16. The system of claim 15, wherein the set of instructions further instructs the processor to:
request a camera to capture an image of the workpiece;
perform an object recognition process on the image;
generate a first set of values based on the object recognition process; and
compare the first set of values against a second set of values such that a compliance of the workpiece to the second set of values is determined.

17. The system of claim 16, wherein the second set of values is based on a set of inputs from a user.

18. The system of claim 16, wherein the set of instructions instructs the processor to:
output the program to a computing device.

19. The system of claim 18, wherein the program is in the delimited format when output to the computing device.

20. The system of claim 15, wherein the set of instructions instructs the processor to:
form an acoustic representation of the workpiece;
perform an object recognition process on the acoustic representation;
generate a first set of values based on the object recognition process; and
compare the first set of values against a second set of values such that a compliance of the workpiece to the second set of values is determined.

21. The system of claim 20, wherein the second set of values is based on a set of inputs from a user.

22. The system of claim 20, wherein the set of instructions instructs the processor to:
output the program to a computing device.

23. The system of claim 22, wherein the program is in the delimited format when output to the computing device.

24. The system of claim 15, wherein the set of instructions instructs the processor to:
form a laser representation of the workpiece;
perform an object recognition process on the laser representation;
generate a first set of values based on the object recognition process; and
compare the first set of values against a second set of values such that a compliance of the workpiece to the second set of values is determined.

25. The system of claim 24, wherein the second set of values is based on a set of inputs from a user.

26. The system of claim 24, wherein the set of instructions instructs the processor to:
output the program to a computing device.

27. The system of claim 26, wherein the program is in the delimited format when output to the computing device.

28. The system of claim 15, wherein the creating, the generating, and the selecting is consecutively and iteratively performed on a layer-by-layer basis.

29. A method comprising:
generating, via a processor, a deposition template for an object based on a set of planar coordinates for the object stored in a spreadsheet and a set of features for the object stored in the spreadsheet, wherein the set of planar coordinates and the set of features are stored in the spreadsheet based on a first user input into an input device in communication with the processor;
converting, via the processor, the deposition template from the spreadsheet into a delimited format;
causing, via the processor, the deposition template in the delimited format to be input into a controller in communication with the processor, a human-machine interface (HMI), and an additive manufacturing system, wherein the processor is distinct from the HMI, wherein the controller is communicably interposed between the processor and the HMI unit, wherein the controller is communicably interposed between the HMI unit and the additive manufacturing system;
causing, via the processor, a logic to be started on the controller based on a second user input into the HMI as the controller stores the deposition template in the delimited format;
causing, via the processor, the logic to read the deposition template in the delimited format stored on the controller such that the logic generates a set of syntax commands on the controller;
causing, via the processor, the set of syntax commands to be sent from the logic on the controller to the additive manufacturing system; and
causing, via the processor, the object to be additively manufactured via the additive manufacturing system based on the set of syntax commands.

30. The method of claim 29, wherein the delimited format includes a comma-separated value (CSV) format exported via the spreadsheet.

31. The method of claim 29, wherein the deposition template is editable via a customized ribbon in the spreadsheet, wherein the customized ribbon contains an icon related to at least one of the set of planar coordinates or the set of features.

32. The method of claim 29, wherein the set of planar coordinates is based on a drawing.

33. The method of claim 29, wherein the set of planar coordinates is generated based on a data structure describing the object.

34. The method of claim 29, wherein the set of planar coordinates is input before the set of features.

35. The method of claim 29, wherein the deposition template is converted into the delimited format based on no errors being detected in the deposition template as the deposition template is error checked via the spreadsheet.

36. The method of claim 29, wherein the template is a visual basic for applications (VBA) for a spreadsheet worksheet.
